(19) United States
(12) Patent Application Publication
(10) Pub. No.: US 2026/0089766 A1
(43) Pub. Date: Mar. 26, 2026

(54) METHODS AND APPARATUSES FOR PRACH REPETITION

(71) Applicant: LENOVO (BEIJING) LIMITED, Beijing (CN)

(72) Inventors: Ruixiang Ma, Beijing (CN); Yuantao Zhang, Beijing (CN); Hongmei Liu, Beijing (CN); Zhi Yan, Beijing (CN); Haiming Wang, Beijing (CN)

(21) Appl. No.: 19/112,640

(22) PCT Filed: Sep. 30, 2022
(86) PCT No.: PCT/CN2022/123279

§ 371 Date: Mar. 18, 2025

(51) Int. Cl. H04W 74/0833; H04W 72/23

(52) U.S. Cl. CPC H04W 74/0833; H04W 72/23

(57) ABSTRACT

Embodiments of the present disclosure relate to methods and apparatuses for physical random access channel (PRACH) repetition. According to some embodiments of the disclosure, a UE may: transmit a plurality of PRACH repetitions for a random access procedure, a BFR procedure, or a link recovery procedure in a plurality of ROs to a network entity; and monitor a PDCCH according to a PRACH repetition of the plurality of PRACH repetitions or an RO of the plurality of ROs.

### TECHNICAL FIELD

Embodiments of the present disclosure generally relate to wireless communication technology, and more particularly to physical random access channel (PRACH) repetition.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

In a wireless communication system, a random access procedure may be utilized for various purposes. For example, it may be utilized by a user equipment (UE) in an initial access to find a cell to camp on. Or it may be utilized by a UE which is in an idle or inactive state (e.g., RRC_IDLE or RRC_INACTIVE state as specified in 3rd generation partnership project (3GPP) specifications) to switch to a connected state (e.g., RRC_CONNECTED state as specified in 3GPP specifications) to start data transmission or reception. Or it may be utilized by a UE in a connected state to reestablish the lost uplink (UL) synchronization, etc. A UE may start a random access procedure by transmitting a preamble in a PRACH (also referred to as a PRACH transmission). The PRACH transmission may also occur in a link recovery procedure or, in other words, a beam failure recovery (BFR) procedure.

However, in some cases, the PRACH may be a bottleneck channel. Given this, how to improve the coverage of the PRACH needs to be addressed.

### SUMMARY

Some embodiments of the present disclosure provide a user equipment (UE). The UE may include a transceiver, and a processor coupled to the transceiver. The processor may be configured to cause the UE to: transmit a plurality of physical random access channel (PRACH) repetitions, for a random access procedure or a beam failure recovery (BFR) procedure, in a plurality of random access channel (RACH) occasions (ROs); and monitor a physical downlink control channel (PDCCH) according to a PRACH repetition of the plurality of PRACH repetitions or an RO of the plurality of ROs.

In some embodiments of the present disclosure, the PDCCH is monitored in a PDCCH monitoring window which is determined according to the PRACH repetition or the RO.

In some embodiments of the present disclosure, in the case of the plurality of PRACH repetitions are for the BFR procedure, the plurality of ROs or the plurality of PRACH repetitions is in the same slot. In some embodiments of the present disclosure, wherein a starting symbol of the PDCCH monitoring window is determined according to a predefined RO of the plurality of ROs or according to a predefined PRACH repetition of the plurality of PRACH repetitions.

In some embodiments of the present disclosure, the processor is further configured to: in response to a failure to monitor the PDCCH, re-transmit a set of PRACH repetitions no later than a first time offset after an ending symbol of the PDCCH monitoring window or after an ending symbol of a physical downlink shared channel (PDSCH) reception scheduled by the PDCCH.

In some embodiments of the present disclosure, the processor is further configured to in response to successfully monitoring the PDCCH, cancel a PRACH repetition of the plurality of PRACH repetitions, wherein a starting symbol of the cancelled PRACH repetition occurs after a second time offset relative to an ending symbol of a control resource set (CORESET) where the PDCCH is detected or an ending symbol of a physical downlink shared channel (PDSCH) reception scheduled by the PDCCH.

In some embodiments of the present disclosure, the PDCCH monitoring window is determined based on a first plurality of PDCCH monitoring windows, and wherein a starting symbol of each of the first plurality of PDCCH monitoring windows is determined according to a respective RO group of a plurality of RO groups including the plurality of ROs or a respective PRACH group of a plurality of PRACH groups including the plurality of PRACH repetitions.

In some embodiments of the present disclosure, the processor is further configured to: in response to a failure to monitor the PDCCH, re-transmit a set of PRACH repetitions no later than a first time offset after an ending symbol of the last window of the first plurality of PDCCH monitoring windows or after an ending symbol of a physical downlink shared channel (PDSCH) reception scheduled by the PDCCH.

In some embodiments of the present disclosure, the processor is further configured to in response to successfully monitoring the PDCCH, cancel a PRACH repetition of the plurality of PRACH repetitions, wherein a starting symbol of the cancelled PRACH repetition occurs after a second time offset relative to an ending symbol of a control resource set (CORESET) where the PDCCH is detected or an ending symbol of a physical downlink shared channel (PDSCH) reception scheduled by the PDCCH.

In some embodiments of the present disclosure, the number of PRACH repetitions of the set of PRACH repetitions is greater than or equal to the number of PRACH repetitions of the plurality of PRACH repetitions.

In some embodiments of the present disclosure, a difference between the number of PRACH repetitions of the set of PRACH repetitions and the number of PRACH repetitions of the plurality of PRACH repetitions is configured by a network entity or predefined.

In some embodiments of the present disclosure, in the case that the predefined RO is not the last RO or the predefined PRACH repetition is not the latest PRACH repetition, a length of the PDCCH monitoring window is based on at least one of: a configurable window duration, a repetition period of the plurality of PRACH repetitions, or a time difference between the predefined PRACH repetition and the last PRACH repetition of the plurality of PRACH repetitions.

In some embodiments of the present disclosure, the PDCCH monitoring window is a single PDCCH monitoring window formed by combining the first plurality of PDCCH monitoring windows. In some embodiments of the present disclosure, a starting symbol of the earliest window of the first plurality of PDCCH monitoring windows and an ending symbol of the last window of the first plurality of PDCCH monitoring windows are determined as a starting symbol and an ending symbol of the PDCCH monitoring window, respectively.

In some embodiments of the present disclosure, the number of ROs in an RO group of the plurality of RO groups, the number of RO groups of the plurality of RO groups, or both are configured by a network entity or predefined. In some embodiments of the present disclosure, the number of PRACH repetitions in a PRACH group of the plurality of PRACH groups, the number of PRACH groups of the plurality of PRACH groups, or both are configured by the network entity or predefined.

In some embodiments of the present disclosure, the starting symbol of a respective PDCCH monitoring window of the first plurality of PDCCH monitoring windows is determined according to a predefined RO in the respective RO group or a predefined PRACH repetition in the respective PRACH group.

In some embodiments of the present disclosure, monitoring the PDCCH includes detecting a downlink control information (DCI) format with a cyclic redundancy check (CRC) scrambled by a random access radio network temporary identifier (RA-RNTI) in a PDCCH monitoring window according to the RO.

In some embodiments of the present disclosure, the RA-RNTI is determined according to a predefined RO of the plurality of ROs. In some embodiments of the present disclosure, the RA-RNTI includes a plurality of RA-RNTIs, each of which is determined according to a respective RO group of a plurality of RO groups including the plurality of ROs.

In some embodiments of the present disclosure, to detect the DCI format with the CRC scrambled by the RA-RNTI in the PDCCH monitoring window, the processor is configured to: detect each of the plurality of RA-RNTIs in the PDCCH monitoring window; or detect a respective RA-RNTI of the plurality of RA-RNTIs in a corresponding sub-window of a plurality of sub-windows, wherein the PDCCH monitoring window includes the plurality of sub-windows; or detect a respective RA-RNTI of the plurality of RA-RNTIs in a corresponding window of a plurality of PDCCH monitoring windows, wherein the PDCCH monitoring window includes the plurality of PDCCH monitoring windows.

In some embodiments of the present disclosure, in the case that at least two PDCCH monitoring windows of the plurality of PDCCH monitoring windows overlap in a time domain, detecting the DCI format with the CRC scrambled by the RA-RNTI in the PDCCH monitoring window includes: detecting the respective RA-RNTIs corresponding to the at least two PDCCH monitoring windows in the overlapped portion of the at least two PDCCH monitoring windows; or detecting a single RA-RNTI among the respective RA-RNTIs corresponding to the at least two PDCCH monitoring windows in the overlapped portion of the at least two PDCCH monitoring windows.

In some embodiments of the present disclosure, the single RA-RNTI is determined based on priorities of the at least two PDCCH monitoring windows.

In some embodiments of the present disclosure, the plurality of PRACH repetitions is transmitted with a plurality of beams, and wherein a beam for the PDCCH monitoring in a PDCCH monitoring window is determined from the plurality of beams according to the PRACH repetition or the RO.

In some embodiments of the present disclosure, the beam for the PDCCH monitoring in the PDCCH monitoring window corresponds to a beam of a predefined PRACH repetition of the plurality of PRACH repetitions or a beam of a predefined RO of the plurality of ROS. In some embodiments of the present disclosure, the beam for the PDCCH monitoring in the PDCCH monitoring window includes a set of beams, each of which corresponds to a respective PRACH repetition group of a plurality of PRACH repetition groups including the plurality of PRACH repetitions or a respective RO of a plurality of RO groups including the plurality of ROs.

In some embodiments of the present disclosure, the predefined RO is the earliest or last RO. In some embodiments of the present disclosure, the predefined PRACH repetition is the earliest or last PRACH repetition.

In some embodiments of the present disclosure, the processor is further configured to: use each of the set of beams in the PDCCH monitoring window; or use a respective beam of the set of beams in a corresponding sub-window of a plurality of sub-windows, wherein the PDCCH monitoring window includes the plurality of sub-windows; or use a respective beam of the set of beams in a corresponding window of a plurality of PDCCH monitoring windows, wherein the PDCCH monitoring window includes the plurality of PDCCH monitoring windows.

In some embodiments of the present disclosure, in the case that at least two PDCCH monitoring windows of the plurality of PDCCH monitoring windows overlap in a time domain, using the respective beam of the set of beams in the corresponding window includes: using the respective beams corresponding to the at least two PDCCH monitoring windows in the overlapped portion of the at least two PDCCH monitoring windows; or using a single beam among the respective beams corresponding to the at least two PDCCH monitoring windows in the overlapped portion of the at least two PDCCH monitoring windows.

In some embodiments of the present disclosure, the single beam is determined based on priorities of the at least two PDCCH monitoring windows.

In some embodiments of the present disclosure, the priority of a PDCCH monitoring window is determined based on at least one of the following: a starting symbol of the PDCCH monitoring window; a starting symbol of an RO associated with the PDCCH monitoring window; or an index of a synchronization signal block (SSB) or a reference signal (CS) associated with the RO.

In some embodiments of the present disclosure, the processor is further configured to use a specific PRACH preamble or a specific PRACH occasion to indicate the PRACH repetition.

In some embodiments of the present disclosure, the number of PRACH repetitions in the plurality of PRACH repetitions is configured in a PRACH configuration table, or is configured per a PRACH format, or is associated with a corresponding PRACH preamble or a corresponding RO.

In some embodiments of the present disclosure, the processor is further configured to determine a beam for a subsequent process of the transmission of the plurality of PRACH repetitions according to the beam for the PDCCH monitoring in the PDCCH monitoring window.

In some embodiments of the present disclosure, the subsequent process includes at least one of: a reception of a physical downlink shared channel (PDSCH) scheduled by the PDCCH, a message 3 transmission, a message 4 reception, or a physical uplink control channel (PUCCH) transmission after the PDCCH monitoring.

In some embodiments of the present disclosure, the beam for the subsequent process of the transmission of the plurality of PRACH repetitions is the same as a beam for receiving the PDCCH in response to the PDCCH monitoring.

Some embodiments of the present disclosure provide a network entity. The network entity may include a transceiver, and a processor coupled to the transceiver. The processor may be configured to cause the network entity to: receive, from a user equipment (UE), a plurality of physical random access channel (PRACH) repetitions, for a random access procedure or beam failure recovery (BFR) procedure, in a plurality of random access channel (RACH) occasions (ROs); and transmit, to the UE, a physical downlink control channel (PDCCH) according to a PRACH repetition of the plurality of PRACH repetitions or an RO of the plurality of ROs.

In some embodiments of the present disclosure, the PDCCH is transmitted in a PDCCH monitoring window which is determined according to the PRACH repetition or the RO.

In some embodiments of the present disclosure, in the case of the plurality of PRACH repetitions are for the BFR, the plurality of ROs or the plurality of PRACH repetitions is in the same slot. In some embodiments of the present disclosure, a starting symbol of the PDCCH monitoring window is determined according to a predefined RO of the plurality of ROs or according to a predefined PRACH repetition of the plurality of PRACH repetitions.

In some embodiments of the present disclosure, the processor is further configured to: receive, from the UE, a set of PRACH repetitions for the random access procedure or BFR procedure no later than a first time offset after an ending symbol of the PDCCH monitoring window or after an ending symbol of a physical downlink shared channel (PDSCH) reception scheduled by the PDCCH.

In some embodiments of the present disclosure, the PDCCH monitoring window is determined based on a first plurality of PDCCH monitoring windows, and wherein a starting symbol of each of the first plurality of PDCCH monitoring windows is determined according to a respective RO group of a plurality of RO groups including the plurality of ROs or a respective PRACH group of a plurality of PRACH groups including the plurality of PRACH repetitions.

In some embodiments of the present disclosure, the processor is further configured to: receive, from the UE, a set of PRACH repetitions for the random access procedure or BFR procedure no later than a first time offset after an ending symbol of the last window of the first plurality of PDCCH monitoring windows or after an ending symbol of a physical downlink shared channel (PDSCH) reception scheduled by the PDCCH.

In some embodiments of the present disclosure, the number of PRACH repetitions of the set of PRACH repetitions is greater than or equal to the number of PRACH repetitions of the plurality of PRACH repetitions.

In some embodiments of the present disclosure, the processor is further configured to transmit, to the UE, a difference between the number of PRACH repetitions of the set of PRACH repetitions and the number of PRACH repetitions of the plurality of PRACH repetitions; or wherein the difference is predefined.

In some embodiments of the present disclosure, in the case that the predefined RO is not the last RO or the predefined PRACH repetition is not the latest PRACH repetition, a length of the PDCCH monitoring window is based on at least one of: a configurable window duration, a repetition period of the plurality of PRACH repetitions, or a time difference between the predefined PRACH repetition and the last PRACH repetition of the plurality of PRACH repetitions.

In some embodiments of the present disclosure, the PDCCH monitoring window is a single PDCCH monitoring window formed by combining the first plurality of PDCCH monitoring windows. In some embodiments of the present disclosure, a starting symbol of the earliest window of the first plurality of PDCCH monitoring windows and an ending symbol of the last window of the first plurality of PDCCH monitoring windows are determined as a starting symbol and an ending symbol of the PDCCH monitoring window, respectively.

In some embodiments of the present disclosure, the number of ROs in an RO group of the plurality of RO groups, the number of RO groups of the plurality of RO groups, or both are configurable by the network entity or predefined. In some embodiments of the present disclosure, the number of PRACH repetitions in a PRACH group of the plurality of PRACH groups, the number of PRACH groups of the plurality of PRACH groups, or both are configurable by the network entity or predefined.

In some embodiments of the present disclosure, the starting symbol of a respective PDCCH monitoring window of the first plurality of PDCCH monitoring windows is determined according to a predefined RO in the respective RO group or a predefined PRACH repetition in the respective PRACH group.

In some embodiments of the present disclosure, transmitting the PDCCH includes transmitting a downlink control information (DCI) with a cyclic redundancy check (CRC) scrambled by a random access radio network temporary identifier (RA-RNTI) in a PDCCH monitoring window, wherein the RA-RNTI is determined according to the RO.

In some embodiments of the present disclosure, the RA-RNTI is determined according to a predefined RO of the plurality of ROs. In some embodiments of the present disclosure, wherein the RA-RNTI is determined according to a plurality of RA-RNTIs, each of which is determined according to a respective RO group of a plurality of RO groups including the plurality of ROS.

In some embodiments of the present disclosure, each RA-RNTI of the plurality of RA-RNTIs corresponds to a sub-window of a plurality of sub-windows, wherein the PDCCH monitoring window includes the plurality of sub-windows. In some embodiments of the present disclosure, each RA-RNTI of the plurality of RA-RNTIs corresponds to a window of a plurality of PDCCH monitoring windows, wherein the PDCCH monitoring window includes the plurality of PDCCH monitoring windows.

In some embodiments of the present disclosure, in the case that at least two PDCCH monitoring windows of the plurality of PDCCH monitoring windows overlap in a time domain, a single RA-RNTI among respective RA-RNTIs corresponding to the at least two PDCCH monitoring windows corresponds to the overlapped portion of the at least two PDCCH monitoring windows.

In some embodiments of the present disclosure, the single RA-RNTI is determined based on priorities of the at least two PDCCH monitoring windows.

In some embodiments of the present disclosure, the plurality of PRACH repetitions is transmitted with a plurality of beams, and wherein a beam for transmitting the PDCCH in a PDCCH monitoring window is determined from the plurality of beams according to the PRACH repetition or the RO.

In some embodiments of the present disclosure, the beam for transmitting the PDCCH in the PDCCH monitoring window corresponds to a beam of a predefined PRACH repetition of the plurality of PRACH repetitions or a beam of a predefined RO of the plurality of ROs. In some embodiments of the present disclosure, wherein the beam for transmitting the PDCCH in the PDCCH monitoring window is determined from a set of beams among the plurality of beams, each beam of the set of beams corresponds to a respective PRACH repetition group of a plurality of PRACH repetition groups including the plurality of PRACH repetitions or a respective RO of a plurality of RO groups including the plurality of ROs.

In some embodiments of the present disclosure, the predefined RO is the earliest or last RO. In some embodiments of the present disclosure, the predefined PRACH repetition is the earliest or last PRACH repetition.

In some embodiments of the present disclosure, each beam of the set of beams corresponds to a sub-window of a plurality of sub-windows, wherein the PDCCH monitoring window includes the plurality of sub-windows. In some embodiments of the present disclosure, each beam of the set of beams corresponds to a window of a plurality of PDCCH monitoring windows, wherein the PDCCH monitoring window includes the plurality of PDCCH monitoring windows.

In some embodiments of the present disclosure, in the case that at least two PDCCH monitoring windows of the plurality of PDCCH monitoring windows overlap in a time domain, a single beam among respective beams corresponding to the at least two PDCCH monitoring windows corresponds to the overlapped portion of the at least two PDCCH monitoring windows.

In some embodiments of the present disclosure, the single beam is determined based on priorities of the at least two PDCCH monitoring windows.

In some embodiments of the present disclosure, the priority of a PDCCH monitoring window is determined based on at least one of the following: a starting symbol of the PDCCH monitoring window; a starting symbol of an RO associated with the PDCCH monitoring window; or an index of a synchronization signal block (SSB) or a reference signal (CS) associated with the RO.

In some embodiments of the present disclosure, the processor is further configured to determine to receive the plurality of PRACH repetitions in response to receiving a specific PRACH preamble or in response to receiving a PRACH preamble in a specific PRACH occasion.

In some embodiments of the present disclosure, the number of PRACH repetitions in the plurality of PRACH repetitions is configured in a PRACH configuration table, or is configured per a PRACH format, or is associated with a corresponding PRACH preamble or a corresponding RO.

In some embodiments of the present disclosure, the plurality of PRACH repetitions is transmitted with a plurality of beams, and the processor is further configured to determine a beam for a subsequent process of the reception of the plurality of PRACH repetitions according to a beam for transmitting the PDCCH.

In some embodiments of the present disclosure, the subsequent process includes at least one of: a transmission of a physical downlink shared channel (PDSCH) scheduled by the PDCCH, a message 3 reception, a message 4 transmission, or a physical uplink control channel (PUCCH) reception after the PDCCH transmission.

In some embodiments of the present disclosure, the beam for the subsequent process of the reception of the plurality of PRACH repetitions is the same as the beam for transmitting the PDCCH.

Some embodiments of the present disclosure provide a method performed by a UE. The method may include: transmitting a plurality of physical random access channel (PRACH) repetitions, for a random access procedure or a beam failure recovery (BFR) procedure, in a plurality of random access channel (RACH) occasions (ROs); and monitoring a physical downlink control channel (PDCCH) according to a PRACH repetition of the plurality of PRACH repetitions or an RO of the plurality of ROs.

Some embodiments of the present disclosure provide a method performed by a network entity. The method may include: receiving, from a user equipment (UE), a plurality of physical random access channel (PRACH) repetitions, for a random access procedure or beam failure recovery (BFR) procedure, in a plurality of random access channel (RACH) occasions (ROs); and transmitting, to the UE, a physical downlink control channel (PDCCH) according to a PRACH repetition of the plurality of PRACH repetitions or an RO of the plurality of ROs.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an exemplary random access procedure in accordance with some embodiments of the present disclosure;

FIGS. 3A-3C illustrate exemplary associations between synchronization signal blocks (SSBs) and ROs in accordance with some embodiments of the present disclosure;

FIG. 4 illustrates a flow chart of an exemplary procedure for transmitting PRACH repetitions in accordance with some embodiments of the present disclosure;

FIGS. 5A-9 illustrate exemplary schematic diagram for PRACH transmissions in accordance with some embodiments of the present disclosure;

FIG. 10 illustrates a flow chart of an exemplary procedure for receiving PRACH repetitions in accordance with some embodiments of the present disclosure; and

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

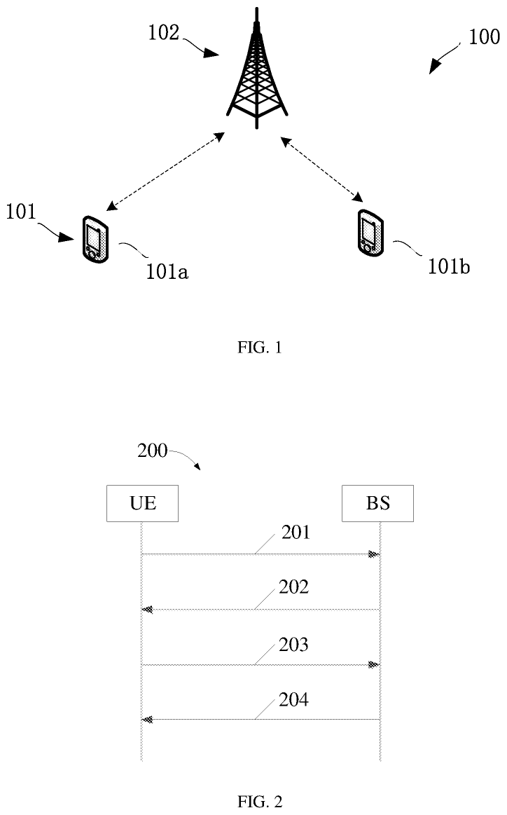

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

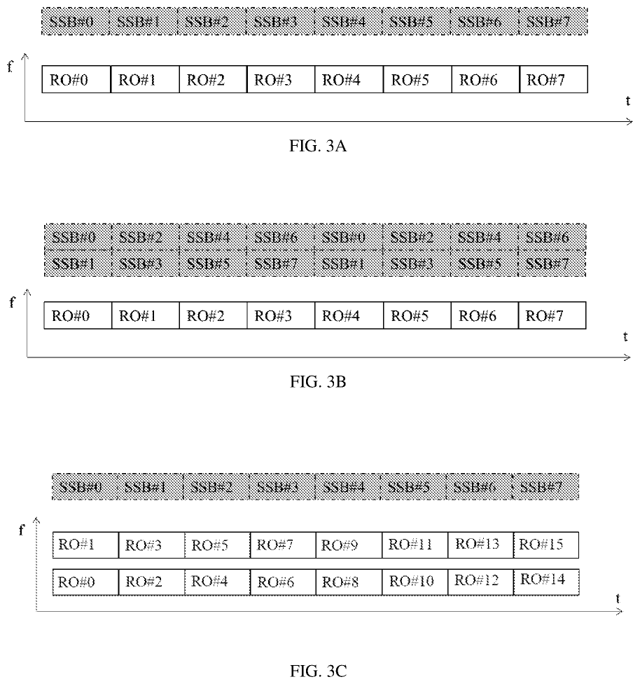

As mentioned above, a random access procedure may be utilized for various purposes. FIG. 2 illustrates an exemplary random access procedure 200 according to some embodiments of the present disclosure. In FIG. 2, the random access procedure may be a 4-step random access channel (RACH) procedure.

Referring to FIG. 2, a UE may start a random access procedure by transmitting, in operation 201, message 1 (also referred to as Msg1) in a RACH occasion (RO) (e.g., a valid RO) to a BS. Msg1 may include a preamble determined by the UE and may also be referred to as a PRACH transmission or a preamble transmission.

In response to receiving Msg1, the BS may transmit a random access response (RAR, also referred to as Msg2) to the UE in operation 202. The RAR may indicate the reception of the preamble and provide necessary information for the transmission of subsequent messages (e.g., message 3 (Msg3) and message 4 (Msg4)). For example, the RAR may include a PDCCH (or named as RAR UL grant) scheduling information for Msg3. In some embodiments, Msg3 may be transmitted using the same beam as Msg1.

The RAR UL grant may be carried by a PDSCH scheduled by a downlink control information (DCI) format (e.g., DCI format 1_0) carried by a PDCCH. The DCI format may be identified (e.g., scrambled) by a certain radio network temporary identifier (RNTI) (e.g., a random access RNTI (RA-RNTI)) which may be determined by at least one of the time position or frequency position of the RO in which the preamble is transmitted. That is, for different ROs, the corresponding RA-RNTIs may be different.

The PDCCH for RAR may be transmitted in a RAR window, which may start after a time gap (i.e., at least one symbol) after the UE transmits Msg1. Such window may also be referred to as a “PDCCH monitor window.” From the perspective of the BS, the BS may need to transmit the PDCCH and the RAR in the PDCCH monitor window.

From the perspective of the UE, after the PRACH transmission, the UE may monitor the PDCCH for the RAR within the PDCCH monitor window. For example, the UE may attempt to detect a DCI format with a CRC scrambled by a corresponding RA-RNTI during the PDCCH monitor window. In some examples, the UE may receive the PDCCH (i.e., the DCI format) and the scheduled RAR within the PDCCH monitor window. In some example, a PDCCH monitoring failure may occur, and the UE may retransmit a PRACH.

In some examples, the UE may determine a PDCCH monitoring failure when one of the following occurs: the UE does not detect the DCI format with the CRC scrambled by the corresponding RA-RNTI within the window; or the UE detects the DCI format with the CRC scrambled by the corresponding RA-RNTI within the window but the least significant bits (LSBs) of a system frame number (SFN) field in the DCI format (if included and applicable) are not the same as the corresponding LSBs of the SFN where the UE transmitted the PRACH; or the UE does not correctly receive the transport block in the corresponding PDSCH within the window; or if the higher layers do not identify the random access preamble identity (RAPID) associated with the PRACH transmission from the UE.

Still referring to FIG. 2, after receiving the RAR, the UE may transmit Msg3 to the BS in operation 203. In response to receiving Msg3, the BS may transmit Msg4 to the UE in operation 204. Msg3 and Msg4 may be used to solve potential collisions due to simultaneous transmissions of the same preamble from different UEs.

In some embodiments of the present disclosure, the preamble or PRACH transmission may take place in a configurable subset of slots that is configured in a PRACH configuration period. Within these slots, there may be one or more frequency domain resources (e.g., ROs) covering multiple consecutive resource blocks.

An RO may be associated with one or more SSBs. An SSB may be associated with a beam. An SSB may include a primary synchronization signal (PSS), a secondary synchronization signal (SSS), and physical broadcast channel (PBCH), and may be used for a UE to synchronize to the downlink (DL), obtain the cell ID, acquire system information, etc.

In some embodiments of the present disclosure, a BS may indicate a plurality of SSBs for a UE. For example, the UE may obtain the indexes of available SSBs in the system information. The UE may measure the channel status of each SSB of the plurality of SSBs, select one SSB with a relatively good channel quality, and transmit a preamble in an RO associated with the selected SSB.

In some embodiments of the present disclosure, the association between SSBs (or beams) and ROs may be configured by the network (e.g., a BS) to a UE. For example, the BS may transmit configuration information to the UE to indicate the association between the SSBs and the ROs.

For example, the association of SSBs (beams) and ROs can be one SSB being associated with one corresponding RO (hereinafter referred to as a 1-to-1 association). For example, the association of SSBs (beams) and ROs can be more than one SSB being associated with one corresponding RO (hereinafter referred to as an N-to-1 association). For example, the association of the SSBs (beams) and the ROs can be one SSB being associated with more than one corresponding RO (hereinafter referred to as a 1-to-N association).

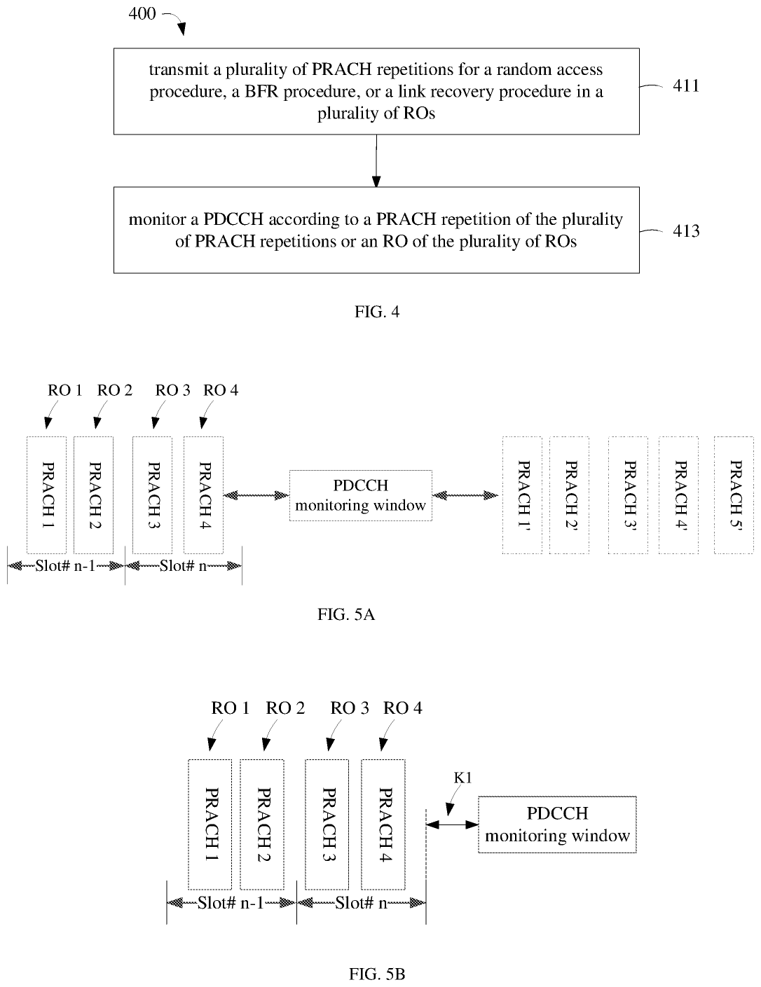

FIGS. 3A-3C illustrates exemplary associations between SSBs and ROs in accordance with some embodiments of the present disclosure.

FIG. 3A shows a 1-to-1 association between SSBs and ROs. In FIG. 3A, it is assumed that there are 8 SSBs indexed from SSB #0 to SSB #7, there is one RO in the frequency domain, and the association period includes 8 ROs indexed from RO #0 to RO #7. Referring to FIG. 3A, SSB #0 to SSB #7 may be mapped to RO #0 to RO #7, respectively.

FIG. 3B shows an N-to-1 association between SSBs and ROs. In FIG. 3B, it is assumed that there are 8 SSBs indexed from SSB #0 to SSB #7, the value of N is 2, there is one RO in the frequency domain, and the association period includes 8 ROs indexed from RO #0 to RO #7. Referring to FIG. 3B, SSB #0 and SSB #1 may be associated with RO #0, SSB #2 and SSB #3 may be associated with RO #1, SSB #4 and SSB #5 may be associated with RO #2, SSB #6 and SSB #7 may be associated with RO #3, SSB #0 and SSB #1 may be associated with RO #4, SSB #2 and SSB #3 may be associated with RO #5, SSB #4 and SSB #5 may be associated with RO #6, and SSB #6 and SSB #7 may be associated with RO #7.

FIG. 3C shows a 1-to-N association between SSBs and ROs. In FIG. 3C, it is assumed that there are 8 SSBs indexed from SSB #0 to SSB #7, the value of N is 2, there are two ROs in the frequency domain and the association period includes 16 ROs indexed from RO #0 to RO #15. Referring to FIG. 3C, SSB #0 may be associated with RO #0 and RO #1, SSB #1 may be associated with RO #2 and RO #3, SSB #2 may be associated with RO #4 and RO #5, SSB #3 may be associated with RO #6 and RO #7, SSB #4 may be associated with RO #8 and RO #9, SSB #5 may be associated with RO #10 and RO #11, SSB #6 may be associated with RO #12 and RO #13, and SSB #7 may be associated with RO #14 and RO #15.

In some embodiments of the present disclosure, the association between SSBs and ROs may be performed periodically in each SSB to RO association period. The association period may be X (e.g., X is a positive integer) times of the PRACH configuration period, and contain one or more SSB to RO mapping cycles. In an embodiment of the present disclosure, the duration of the SSB to RO association period may be a minimum period such that within the SSB to RO association period, each SSB is associated with at least one RO.

In addition to the random access procedure as described above, the PRACH transmission may also occur in a link recovery procedure or, in other words, a BFR procedure.

In some embodiments of the present disclosure, a UE can be provided a configuration for PRACH transmission for link recovery or BFR (e.g., by “PRACH-ResourceDedicatedBFR” as specified in 3GPP specifications). For a PRACH transmission in a certain slot and according to antenna port quasi co-location parameters associated with periodic CSI reference signal (CSI-RS) resource configuration or with SS/PBCH block associated with a certain index provided by higher layers (e.g., q_{new} as specified in 3GPP specifications), the UE may monitor a PDCCH in a search space set for detection of a DCI format with a CRC scrambled by a certain RNTI (e.g., cell-RNTI (C-RNTI) or a modulation and coding scheme (MCS) C-RNTI (MCS-C-RNTI)) after a time gap after the PRACH transmission within a PDCCH monitoring window.

In some embodiments of the present disclosure, for the PDCCH monitoring and the corresponding PDSCH receptions, the UE may assume the same antenna port quasi-collocation parameters as the ones associated with the certain index (e.g., q_{new}) until, for example, the UE receives an activation for a transmission configuration indication (TCI) state. In some embodiments of the present disclosure, the UE may transmit a physical uplink control channel (PUCCH) using the same spatial filter as for the last PRACH transmission.

Some communication technology may support preamble or PRACH transmission without repetition. However, in some cases, the PRACH may be the bottleneck channel which has bad coverage performance, for example, when a short PRACH format (e.g., PRACH format B4 as specified in 3GPP specification TS 38.211) is used. Embodiments of the present disclosure provide solutions for improving the coverage of the PRACH.

In some embodiments of the present disclosure, PRACH repetition is introduced for PRACH coverage enhancement. In some embodiments, a PRACH may be repeated (each may be referred to as “a PRACH repetition”) in a plurality of ROs in a time division multiplexing (TDM) manner, a frequency division multiplexing (FDM) manner or both. In some examples, there may be multiple time domain units (e.g., slots or symbols) occupied by multiple PRACH repetitions.

Various issues may arise when PRACH repetition is introduced. For example, in the case of the initial access procedure, since there are multiple ROs corresponding to multiple PRACH repetitions, how to determine the PDCCH monitoring window, and how to determine the RA-RNTI to be detected in the PDCCH monitoring window should be considered. In addition, in the case that the multiple PRACH repetitions are transmitted with different beams, how to determine the beam for PDSCH reception should be considered. For example, in the case of link recovery or BFR, since there are multiple ROs corresponding to multiple PRACH repetitions, how to determine the PDCCH monitoring window should be considered. In addition, in the case that the multiple PRACH repetitions are transmitted with different beams, which beam does the UE assume the same antenna port quasi-collocation parameters for PDCCH monitoring and PUCCH transmission should be considered.

Embodiments of the present disclosure provide solutions that can solve at least the above issues when PRACH repetition is supported. More details on the embodiments of the present disclosure will be illustrated in the following text in combination with the appended drawings.

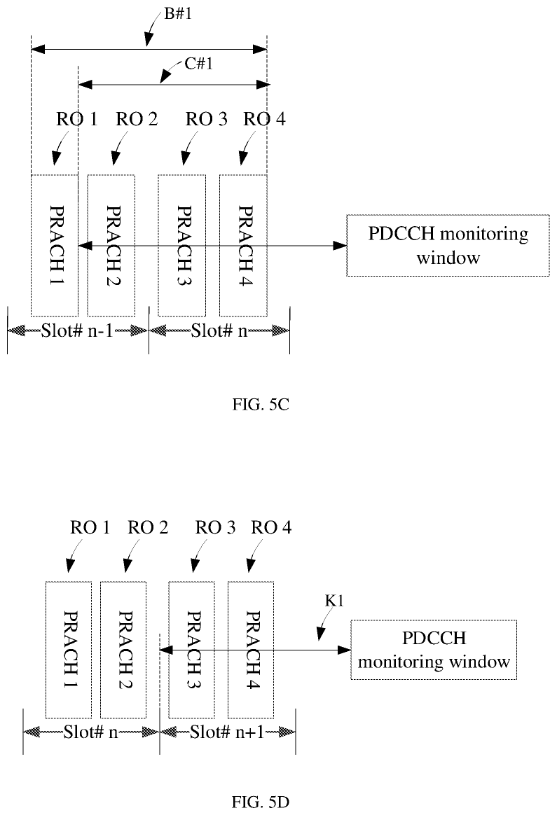

FIG. 4 illustrates a flow chart of exemplary procedure 400 for transmitting PRACH repetitions in accordance with some embodiments of the present disclosure. Procedure 400 may be implemented by a UE (e.g., UE 101 as shown in FIG. 1). Details described in all of the foregoing embodiments of the present disclosure are applicable for the embodiments shown in FIG. 4.

Referring to FIG. 4, in operation 411, a UE may transmit a plurality of PRACH repetitions for a random access procedure, a BFR procedure, or a link recovery procedure in a plurality of ROs to a network entity (e.g., BS 102 as shown in FIG. 1).

In some embodiments, the plurality of ROs may be a plurality of valid ROs. The definition of valid RO can be found in 3GPP specifications (e.g., 3GPP specification TS 38.213). In some embodiments, at least two ROs of the plurality of ROs may have different time domain resources or be at different time units (e.g., different slots, symbols, subframes, mini-slots, sub-slots, or frames).

In some embodiments of the present disclosure, the UE may need to indicate the network (e.g., a network entity such as a BS) whether the PRACH is transmitted with repetition or not. In some examples, a specific PRACH preamble or a specific PRACH occasion may be employed to indicate the PRACH repetition. For example, when the network entity receives the specific PRACH preamble from the UE, the network entity would know that the PRACH or preamble is to be transmitted with repetition. For example, when the network entity receives a PRACH or preamble in a specific PRACH occasion (e.g., a specific RO) from the UE, the network entity would know that the PRACH or preamble is to be transmitted with repetition.

In some embodiments of the present disclosure, the number of PRACH repetitions in the plurality of PRACH repetitions may be configured in a PRACH configuration table; and when a network entity indicates the PRACH configuration by an index (e.g., 8-bit) in system information block 1 (SIB1), the number of repetition could be indicated. In some embodiments of the present disclosure, multiple numbers of PRACH repetitions could be configured by a network entity separately; and when the network entity indicates the PRACH configuration by an index (e.g., 8-bit) in SIB1, the number of repetition could be indicated. In some embodiments of the present disclosure, the number of repetition may be configured per a PRACH format; and then if the format is indicated, the number of repetition is determined. In some embodiments of the present disclosure, the number of repetition may be associated with a corresponding PRACH preamble or a corresponding RO. For example, different PRACH preambles or ROs may correspond to different numbers of PRACH repetitions.

In operation 413, the UE may monitor a PDCCH according to a PRACH repetition of the plurality of PRACH repetitions or an RO of the plurality of ROs. For example, the UE may monitor the PDCCH according to at least one PRACH repetition of the plurality of PRACH repetitions. For example, the UE may monitor the PDCCH according to at least one RO of the plurality of ROs.

In some embodiments of the present disclosure, the UE may monitor the PDCCH in a PDCCH monitoring window. The PDCCH monitoring window may be determined according to the PRACH repetition or the RO (e.g., the at least one PRACH repetition or the at least one RO).

In some embodiments of the present disclosure, in the case of the plurality of PRACH repetitions is for the BFR procedure or the link recovery procedure, the plurality of ROs or the plurality of PRACH repetitions may be in the same slot. The PDCCH monitoring window for the BFR procedure or the link recovery procedure may be determined according any RO of the plurality of ROs or any PRACH of the plurality of PRACH repetitions.

For example, assuming that the plurality of PRACH repetitions is transmitted in slot A (that is, the plurality of ROs are within slot #A), the PDCCH monitoring window may be determined as starting from slot A+K1, wherein K1 represents a slot level offset. For example, K1 may be equal to 4+2^{μ}·k_{mac}, where μ is the subcarrier spacing (SCS) configuration for the PRACH transmission and k_{mac} is a number of slots representing a scheduling offset. For example, k_{mac} may be provided by K-Mac or k_{mac}=0 if K-Mac is not provided. The definitions of k_{mac} and K-Mac are specified in 3GPP specifications. The duration of the PDCCH monitoring window may be configured by a network entity such as a BS (e.g., via BeamFailureRecoveryConfig as specified in 3GPP specifications).

In some embodiments of the present disclosure, the starting symbol of the PDCCH monitoring window may be determined according to a predefined RO of the plurality of ROs or according to a predefined PRACH repetition of the plurality of PRACH repetitions.

For example, the predefined PRACH repetition may be the last PRACH repetition of the plurality of PRACH repetitions. For example, the predefined RO may be the last RO of the plurality of ROs. The last RO can also be referred to as the RO of the last PRACH repetition.

In response to a PRACH transmission, a UE attempts to detect a DCI format (e.g., DCI format 1_0) with a CRC scrambled by a corresponding RA-RNTI during a window controlled by higher layers. The window starts at the first symbol of the earliest control resource set (CORESET) the UE is configured to receive PDCCH for Type1-PDCCH common search space (CSS) set, that is at least one symbol, after the last symbol of the last PRACH occasion corresponding to the PRACH transmission (or the last symbol of the PRACH occasion corresponding to the last PRACH repetition), where the (symbol) duration of the window corresponds to the SCS for Type1-PDCCH CSS set.

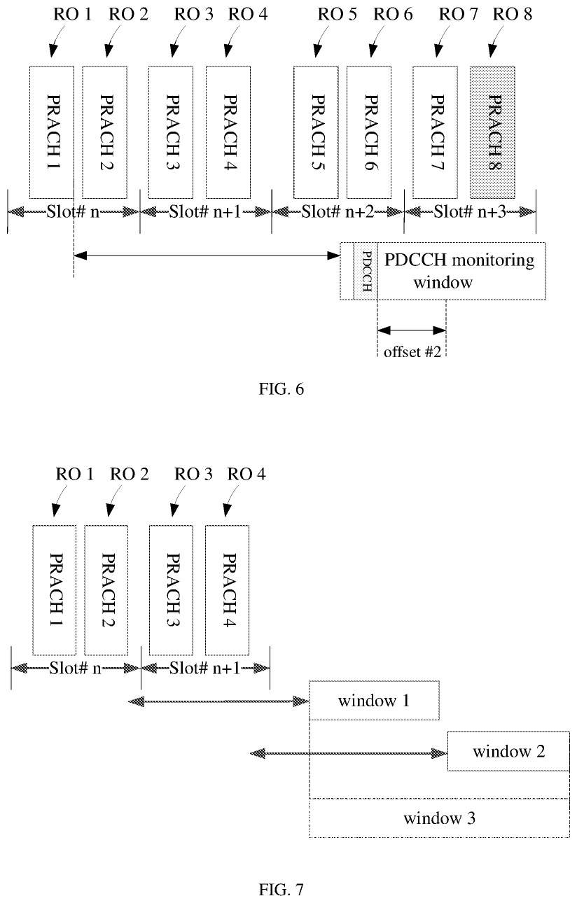

Referring to FIG. 5A, a UE may transmit, to a BS, a plurality of PRACH repetitions (e.g., PRACHs 1-4) on a plurality of ROs (e.g., ROs 1-4) during a random access procedure. The plurality of PRACH repetitions is transmitted in slot #n−1 and slot #n, wherein PRACH 1 and PRACH 2 are transmitted in slot #n−1 and PRACH 3 and PRACH 4 are transmitted in slot #n.

The UE may attempt to detect a DCI format within a PDCCH monitoring window as shown in FIG. 5A. The starting symbol of the PDCCH monitoring window may be determined based on the last PRACH repetition (i.e., PRACH 4) of PRACHs 1-4. For example, the PDCCH monitoring window may start at the first symbol of the earliest control resource set (CORESET) the UE is configured to receive PDCCH for Type1-PDCCH common search space (CSS) set, that is at least one symbol, after the last symbol of RO 4 (or the RO corresponding to PRACH 4). The (symbol) duration of the PDCCH monitoring window may correspond to the SCS for Type1-PDCCH CSS set.

Referring to FIG. 5B, a UE may transmit, to a BS, a plurality of PRACH repetitions (e.g., PRACHs 1-4) on a plurality of ROs (e.g., ROs 1-4) during a BFR procedure or a link recovery procedure. The plurality of PRACH repetitions is transmitted in slot #n−1 and slot #n, wherein PRACH 1 and PRACH 2 are transmitted in slot #n−1 and PRACH 3 and PRACH 4 are transmitted in slot #n.

For the last PRACH repetition (e.g., PRACH 4) in slot n, the UE monitors a PDCCH in a search space set (e.g., provided by recoverySearchSpaceId as specified in 3GPP specifications) for detection of a DCI format with a CRC scrambled by C-RNTI or MCS-C-RNTI starting from slot #n+K1.

The UE may attempt to detect a DCI format within a PDCCH monitoring window as shown in FIG. 5B. For example, since the last PRACH repetition (e.g., PRACH 4) or since the last RO (e.g., RO 4) is in slot #n, the UE may monitor a PDCCH in a search space set (e.g., provided by recoverySearchSpaceId as specified in 3GPP specifications) for detection of a DCI format starting from slot #n+K1.

In response to a failure to monitor the PDCCH, the UE may retransmit a PRACH. For example, a higher layer(s) of the UE can indicate the physical layer to retransmit a PRACH. In some embodiments of the present disclosure, the PRACH may be retransmitted with repetitions. For example, the UE shall be ready to transmit a PRACH (e.g., a set of PRACH repetitions) no later than a time offset (denoted as offset #1) after an ending symbol of the PDCCH monitoring window or after an ending symbol of a PDSCH reception scheduled by the PDCCH.

In some examples, offset #1 may be equal to N_{T,1}+0.75 msec, where N_{T,1} as specified in 3GPP specifications is a time duration of N_1 symbols corresponding to a PDSCH processing time for UE processing capability 1.

In some embodiments of the present disclosure, the number of PRACH repetitions of the set of PRACH repetitions is greater than or equal to the number of PRACH repetitions of the plurality of PRACH repetitions. Or put another way, the repetition number of the retransmitted PRACH may be equal to or larger than the initial PRACH transmission.

For example, referring to FIG. 5A, in the case of a PDCCH monitoring failure, the UE may be ready to transmit a PRACH (e.g., retransmit a set of PRACH repetitions (e.g., PRACHs 1′-5′)) after a time offset from the ending symbol of the PDCCH monitoring window.

In some embodiments of the present disclosure, a difference between the number of PRACH repetitions of the set of PRACH repetitions and the number of PRACH repetitions of the plurality of PRACH repetitions is configured by a BS or predefined, for example, in a standard(s). Or put another way, the increased repetition number may be a default value or configured by a BS.

For example, in the example shown in FIG. 5A, a difference of “1” may be configured by a BS or predefined such that in the case of a PDCCH monitoring failure, the UE may retransmit 4+1 PRACH repetitions (i.e., PRACHs 1′-5′).

For example, the predefined PRACH repetition may be the earliest (first) PRACH repetition of the plurality of PRACH repetitions. For example, the predefined RO may be the earliest (first) RO of the plurality of ROs. The earliest RO can also be referred to as the RO of the earliest PRACH repetition.

In response to a PRACH transmission, a UE attempts to detect a DCI format (e.g., DCI format 1_0) with a CRC scrambled by a corresponding RA-RNTI during a window controlled by higher layers. The window starts at the first symbol of the earliest CORESET the UE is configured to receive PDCCH for Type1-PDCCH CSS set, that is at least one symbol, after the last symbol of the PRACH occasion corresponding to the first PRACH repetition, where the (symbol) duration of the window corresponds to the SCS for Type1-PDCCH CSS set.

Referring to FIG. 5C, a UE may transmit, to a BS, a plurality of PRACH repetitions (e.g., PRACHs 1-4) on a plurality of ROs (e.g., ROs 1-4) during a random access procedure. The plurality of PRACH repetitions is transmitted in slot #n−1 and slot #n, wherein PRACH 1 and PRACH 2 are transmitted in slot #n−1 and PRACH 3 and PRACH 4 are transmitted in slot #n.

The UE may attempt to detect a DCI format within a PDCCH monitoring window as shown in FIG. 5C. The starting symbol of the PDCCH monitoring window may be determined based on the first PRACH repetition (i.e., PRACH 1) of PRACHs 1-4. For example, the PDCCH monitoring window may start at the first symbol of the earliest CORESET the UE is configured to receive PDCCH for Type1-PDCCH CSS set, that is at least one symbol, after the last symbol of RO 1 (or the RO corresponding to PRACH 1). The (symbol) duration of the PDCCH monitoring window may correspond to the SCS for Type1-PDCCH CSS set.

For the first PRACH repetition (e.g., PRACH 1) in slot #n−1, the UE monitors a PDCCH in a search space set (e.g., provided by recoverySearchSpaceId as specified in 3GPP specifications) for detection of a DCI format with a CRC scrambled by C-RNTI or MCS-C-RNTI starting from slot ( #n−1)+K1.

Referring to FIG. 5D, a UE may transmit, to a BS, a plurality of PRACH repetitions (e.g., PRACHs 1-4) on a plurality of ROs (e.g., ROs 1-4) during a BFR procedure or a link recovery procedure. The plurality of PRACH repetitions is transmitted in slot #n and slot #n+1, wherein PRACH 1 and PRACH 2 are transmitted in slot #n and PRACH 3 and PRACH 4 are transmitted in slot #n+1.

The UE may attempt to detect a DCI format within a PDCCH monitoring window as shown in FIG. 5D. For example, since the first PRACH repetition (e.g., PRACH 1) or since the first RO (e.g., RO 1) is in slot #n, the UE may monitor a PDCCH in a search space set (e.g., provided by recoverySearchSpaceId as specified in 3GPP specifications) for detection of a DCI format starting from slot #n+K1.

In response to a failure to monitor the PDCCH, the UE may retransmit a PRACH. For example, a higher layer(s) of the UE can indicate the physical layer to retransmit a PRACH. In some embodiments of the present disclosure, the PRACH may be retransmitted with repetitions. For example, the UE shall be ready to transmit a set of PRACH repetitions no later than a time offset (e.g., offset #1 as described above) after an ending symbol of the PDCCH monitoring window or after an ending symbol of a PDSCH reception scheduled by the PDCCH.

In some embodiments of the present disclosure, the number of PRACH repetitions of the set of PRACH repetitions is greater than or equal to the number of PRACH repetitions of the plurality of PRACH repetitions. In some embodiments of the present disclosure, a difference between the number of PRACH repetitions of the set of PRACH repetitions and the number of PRACH repetitions of the plurality of PRACH repetitions is configured by a network entity (e.g., a BS) or predefined, for example, in a standard(s).

In some embodiments of the present disclosure, the length of the PDCCH monitoring window may be based on at least one of: (A) a configurable window duration; (B) a repetition period of the plurality of PRACH repetitions (or a repetition period of the plurality of ROs); or (C) a time difference between the predefined PRACH repetition and the last PRACH repetition of the plurality of PRACH repetitions (a time difference between the predefined RO and the last RO of the plurality of ROs).

For example, the configurable window duration may be a duration for PRACH transmission without repetition. For example, the configurable window duration may be for PRACH transmission with repetition. For example, in the case that the predefined RO is not the last RO or the predefined PRACH repetition is not the last PRACH repetition, the length of the window may be equal to (A), or (A)+(B) or (A)+(C). For example, referring back to FIG. 5C, the length of the PDCCH monitoring window may be equal to (A)+(B #1) or (A)+(C #1).

In some embodiments of the present disclosure, in response to successfully monitoring the PDCCH, the UE may cancel a PRACH repetition of the plurality of PRACH repetitions, wherein the starting symbol of the cancelled PRACH repetition occurs after a time offset (denoted as offset #2) relative to an ending symbol of a CORESET where the PDCCH is detected or an ending symbol of the PDSCH reception scheduled by the PDCCH. In some examples, offset #2 may be equal to T_{proc,2}, or T_{proc,2}+d, or Ngap. The definitions of the parameters or variables in the aforementioned formula(s) for determining offset #2 can be found 3GPP specifications.

In some embodiments, successfully monitoring the PDCCH may mean that: the UE detects the DCI format with the CRC scrambled by the corresponding RA-RNTI within the window, LSBs of an SFN field in the DCI format (if included and applicable) are the same as the corresponding LSBs of the SFN where the UE transmitted the PRACH, the UE receives a transport block in a corresponding PDSCH within the window, the UE passes the transport block to higher layers (e.g., the layers higher than the physical layer), and the higher layers parse the transport block for a RAPID associated with the PRACH transmission.

Referring to FIG. 6, a plurality of PRACH repetitions (e.g., PRACHs 1-8) is to be transmitted by a UE on a plurality of ROs (e.g., ROs 1-8) during a random access procedure, a BFR procedure or a link recovery procedure. The plurality of PRACH repetitions may be transmitted in slots #n to slot #n+3. A PDCCH monitoring window can be determined according to various methods as described above. For example, the PDCCH monitoring window as shown in FIG. 6 may be determined according to PRACH 1. In some examples, the UE may successfully receive and decode a PDCCH in the PDCCH monitoring window. The UE may cancel PRACH 8 since the distance between the starting symbol of PRACH 8 and the ending symbol of a CORESET where the PDCCH is detected is greater than offset #2.

In some embodiments of the present disclosure, the PDCCH monitoring window may be determined based on a plurality of PDCCH monitoring windows. The starting symbol of each of the plurality of PDCCH monitoring windows may be determined according to a respective RO group of a plurality of RO groups including the plurality of ROs or a respective PRACH group of a plurality of PRACH groups including the plurality of PRACH repetitions. The number of ROs in an RO group or the number of PRACH repetitions in a PRACH group can be equal to or greater than 1.

The starting symbol of a respective PDCCH monitoring window of the plurality of PDCCH monitoring windows may be determined according to a predefined RO in the respective RO group or a predefined PRACH repetition in the respective PRACH group.

For example, in the case that there is only one member in an RO group or a PRACH group, the starting symbol of each of the plurality of PDCCH monitoring windows can be determined according to each of the plurality of ROs or each of the plurality of PRACH repetitions.

For example, in the case that there are multiple members in an RO group or a PRACH group, the starting symbol of each of the plurality of PDCCH monitoring windows can be determined according to the last or first RO of the multiple ROs of each RO group or according to the last or first PRACH repetition of the multiple PRACH repetitions of each PRACH group. ROs of each RO group can also be referred to as ROs of each PRACH group.

In some embodiments, the number of ROs (denoted as Q) in an RO group of the plurality of RO groups, the number of RO groups (denoted as N) of the plurality of RO groups, or both may be configured by a network entity (e.g., a BS) or predefined. The plurality of ROs can be grouped as the plurality of RO groups based on, for example, the number of repetitions of the plurality of PRACH repetitions (or the number of ROs of the plurality of ROs) and one of N and Q.

In some embodiments, the number of PRACH repetitions (denoted as Q′) in a PRACH group of the plurality of PRACH groups, the number of PRACH groups (denoted as N′) of the plurality of PRACH groups, or both may be configured by the network entity or predefined. The plurality of PRACH repetitions can be grouped as the plurality of PRACH groups based on, for example, the number of repetitions of the plurality of PRACH repetitions (or the number of ROs of the plurality of ROs) and one of N′ and Q′.

For example, the plurality of ROs may be divided into a plurality of RO groups, and a PDCCH monitoring window may be determined based on each RO group. For example, the plurality of PRACH repetitions may be divided into a plurality of PRACH groups, and a PDCCH monitoring window may be determined based on each PRACH group. In this way, the plurality of PDCCH monitoring windows can be determined. The plurality of PDCCH monitoring windows may or may not be consecutive in the time domain.

In some embodiments of the present disclosure, the plurality of PDCCH monitoring windows may be combined to form a single PDCCH monitoring window. The UE may monitor the PDCCH in the single PDCCH monitoring window.

In some embodiments of the present disclosure, the starting symbol of the earliest (first) window of the plurality of PDCCH monitoring windows and an ending (last) symbol of the last window of the plurality of PDCCH monitoring windows may be respectively determined as a starting symbol and an ending symbol of the final PDCCH monitoring window. That is, the final PDCCH monitoring window may occupy the time starting from the starting symbol of the earliest window of the plurality of PDCCH monitoring windows till the ending symbol of the last window of the plurality of PDCCH monitoring windows. The UE may monitor the PDCCH in the final PDCCH monitoring window.

Or put another way, the final PDCCH monitoring occasions may be the union of all the PDCCH monitoring occasions in all of the plurality of PDCCH monitoring windows.

Referring to FIG. 7, a UE may transmit, to a BS, a plurality of PRACH repetitions (e.g., PRACHs 1-4) on a plurality of ROs (e.g., ROs 1-4) during a random access procedure, a BFR procedure or a link recovery procedure. The plurality of PRACH repetitions may be transmitted in slots #n to slot #n+1.

It is assumed that N=2, PRACHs 1-4 are divided into two groups, i.e., group #1 including PRACHs 1 and 2, and group #2 including PRACHs 3 and 4. Or put another way, ROs 1-4 are divided into two groups, i.e., group #1′ including ROs 1 and 2, and group #2′ including ROs 3 and 4.

For each group, a respective PDCCH monitoring window can be determined. It is assumed that the last group member is used as the basis for determining the respective PDCCH monitoring window. For example, as shown in FIG. 7, window 1 can be determined according to RO 2 or PRACH 2. Window 2 can be determined according to RO 4 or PRACH 4. Although in FIG. 7, window 1 and window 2 do not overlap in the time domain, it is contemplated that window 1 and window 2 may overlap in the time domain in some other embodiments of the present disclosure.

In some embodiments of the present disclosure, window 1 and window 2 may be combined as a single window (e.g., window 3) for PDCCH monitoring. In some embodiments of the present disclosure, window 1 and window 2 may not be combined and the UE may perform PDCCH monitoring in each of window 1 and window 2.

In response to a failure to monitor the PDCCH in the PDCCH monitoring window, the UE may retransmit a PRACH. For example, a higher layer(s) of the UE can indicate the physical layer to retransmit a PRACH. In some embodiments of the present disclosure, the PRACH may be retransmitted with repetitions. For example, the UE may be ready to retransmit a set of PRACH repetitions no later than a time offset (e.g., offset #1) after an ending symbol of the last window of the plurality of PDCCH monitoring windows or after an ending symbol of a PDSCH reception scheduled by the PDCCH.

In some embodiments of the present disclosure, the number of PRACH repetitions of the set of PRACH repetitions is greater than or equal to the number of PRACH repetitions of the plurality of PRACH repetitions. Or put another way, the repetition number of the PRACH may be equal to or larger than the initial PRACH transmission.

In some embodiments of the present disclosure, a difference between the number of PRACH repetitions of the set of PRACH repetitions and the number of PRACH repetitions of the plurality of PRACH repetitions is configured by a BS or predefined, for example, in a standard(s). Or put another way, the increased repetition number may be a default value or configured by a BS.

In some embodiments of the present disclosure, in response to successfully monitoring the PDCCH, the UE may cancel a PRACH repetition of the plurality of PRACH repetitions, wherein the starting symbol of the cancelled PRACH repetition occurs after a time offset (e.g., offset #2) relative to an ending symbol of a CORESET where the PDCCH is detected or an ending symbol of the PDSCH reception scheduled by the PDCCH.

As mentioned above, the UE may monitor a PDCCH according to a PRACH repetition of the plurality of PRACH repetitions or an RO of the plurality of ROs in operation 413. In some embodiments of the present disclosure, monitoring the PDCCH may include detecting a DCI format with a CRC scrambled by an RA-RNTI in a PDCCH monitoring window according to the PRACH repetition or the RO. More specifically, the UE may attempt to detect a DCI format with a CRC scrambled by an RA-RNTI within each PDCCH monitoring occasion in the PDCCH monitoring window. For simplicity, “detecting a DCI format with a CRC scrambled by an RA-RNTI” may also be referred to as “detecting an RA-RNTI” in the context of the present disclosure.

In some embodiments of the present disclosure, the RA-RNTI may be determined according to a predefined RO of the plurality of ROs or an RO of a predefined PRACH repetition of the plurality of PRACH repetitions.

For example, the predefined PRACH repetition may be the last (or first) PRACH repetition of the plurality of PRACH repetitions. For example, the predefined RO may be the last (or first) RO of the plurality of ROs. The last (or first) RO can also be referred to as the RO of the last (or first) PRACH repetition.

For example, referring back to FIG. 5A, the UE may attempt to detect a DCI format with a CRC scrambled by an RA-RNTI, which is determined based on the last RO (i.e., RO 4) or the RO (i.e., RO 4) of the last PRACH repetition (i.e., PRACH 4), in the PDCCH monitoring window.

In some embodiments of the present disclosure, the RA-RNTI may include a plurality of RA-RNTIs, each of which may be determined according to a respective RO group of a plurality of RO groups including the plurality of ROs or a respective PRACH group of a plurality of PRACH groups including the plurality of PRACH repetitions.

The number of ROs in an RO group or the number of PRACH repetitions in a PRACH group can be equal to or greater than 1. The methods for determining the plurality of RO groups and the plurality of PRACH groups as described above may apply here.

In some embodiments of the present disclosure, the UE may detect each of the plurality of RA-RNTIs in the PDCCH monitoring window. For example, the UE may attempt to detect all of the plurality of RA-RNTIs within each PDCCH monitoring occasion in the PDCCH monitoring window.

For example, it is assumed that the number of ROs in an RO group is assumed as 1. For example, referring to FIG. 5A, for each RO of ROs 1-4, the UE may determine a corresponding RA-RNTI, and the UE may attempt to detect a DCI format with a CRC scrambled by the corresponding RA-RNTI in the PDCCH monitoring window. For example, the UE may attempt to detect a DCI format with a CRC scrambled by the RA-RNTI determined accruing to RO 1 in the PDCCH monitoring window, the UE may attempt to detect a DCI format with a CRC scrambled by the RA-RNTI determined accruing to RO 2 in the PDCCH monitoring window, the UE may attempt to detect a DCI format with a CRC scrambled by the RA-RNTI determined accruing to RO 3 in the PDCCH monitoring window, and the UE may attempt to detect a DCI format with a CRC scrambled by the RA-RNTI determined accruing to RO 4 in the PDCCH monitoring window.

For example, the number of ROs in an RO group is assumed as 2. For example, referring to FIG. 7, ROs 1-4 are divided into two groups, i.e., group #1′ including ROs 1 and 2, and group #2′including ROs 3 and 4. It is assumed that window 3 in FIG. 7 is the final window for PDCCH monitoring. For each of group #1′and group #2′, the UE may determine a corresponding RA-RNTI, and the UE may attempt to detect a DCI format with a CRC scrambled by the corresponding RA-RNTI in window 3. Since there is more than one RO in the RO groups, the UE may determine the RA-RNTI corresponding to a respective RO group according to a predefined RO in the respective RO group. For example, the UE may determine RA-RNTI #1 according to RO 2 (last RO) in group #1′, and RA-RNTI #2 according to RO 4 (last RO) in group #2′. The UE may attempt to detect a DCI format with a CRC scrambled by RA-RNTI #1 in window 3 and attempt to detect a DCI format with a CRC scrambled by RA-RNTI #2 in window 3.

In some embodiments of the present disclosure, the UE may detect a respective RA-RNTI of the plurality of RA-RNTIs in a corresponding sub-window of a plurality of sub-windows, wherein the PDCCH monitoring window comprises the plurality of sub-windows.

For example, the PDCCH monitoring window may be divided into a plurality of sub-windows, the plurality of ROs may be divided into a plurality of RO groups, and each sub-window may correspond to a RO group. As mentioned above, the number of ROs in an RO group can be equal to or greater than 1. For each RO group, the UE may determine a corresponding RA-RNTI. The methods for determining the plurality of RO groups and the RA-RNTI corresponding to an RO group as described above may apply here. The UE may attempt to detect the corresponding RA-RNTI in a corresponding sub-window in the PDCCH monitoring window.

For example, referring to FIG. 8, a UE may transmit, to a BS, a plurality of PRACH repetitions (e.g., PRACHs 1-4) on a plurality of ROs (e.g., ROs 1-4) during a random access procedure. The plurality of PRACH repetitions may be transmitted in slot #n−1 and slot #n.

The UE may determine a PDCCH monitoring window as shown in FIG. 8 according to various methods as described above or other methods that can be conceived of by persons skilled in the art. For example, the starting symbol of the PDCCH monitoring window may be determined based on the last PRACH repetition (i.e., PRACH 4) of PRACHs 1-4. The PDCCH monitoring window may be divided into a plurality of sub-windows (e.g., sub-windows #1 to #4), each corresponding to one of ROs 1-4. The UE may determine an RA-RNTI corresponding to each sub-window according to the corresponding RO and may detect the RA-RNTI in the corresponding sub-window. For example, the UE may determine an RA-RNTI according to RO 1, and attempt to detect the RA-RNTI in sub-window #1. The UE may determine an RA-RNTI according to RO 2, and attempt to detect the RA-RNTI in sub-window #2. The UE may determine an RA-RNTI according to RO 3, and attempt to detect the RA-RNTI in sub-window #3. The UE may determine an RA-RNTI according to RO 4, and attempt to detect the RA-RNTI in sub-window #4.

In some embodiments of the present disclosure, the UE may detect a respective RA-RNTI of the plurality of RA-RNTIs in a corresponding window of a plurality of PDCCH monitoring windows, wherein the PDCCH monitoring window comprises the plurality of PDCCH monitoring windows. The plurality of PDCCH monitoring windows can overlap or not overlap each other.

For example, according to the methods as described above or other methods that can be conceived of by persons skilled in the art, the UE may determine a plurality of PDCCH monitoring windows and may monitor a PDCCH in each of the PDCCH monitoring windows. For each PDCCH monitoring window, the UE may attempt to detect a respective RA-RNTI in a corresponding window.

For example, referring to FIG. 7, window 1 can be determined according to RO 2 or PRACH 2, and window 2 can be determined according to RO 4 or PRACH 4. It is assumed that the UE may determine window 1 and window 2 as the plurality of PDCCH monitoring windows. In each of window 1 and window 2, the UE may determine a corresponding RA-RNTI. For example, the UE may determine an RA-RNTI corresponding to window 1 according to RO 2 and may determine an RA-RNTI corresponding to window 2 according to RO 4. The UE may detect the RA-RNTI corresponding to window 1 in window 1 and detect the RA-RNTI corresponding to window 2 in window 2.

In some embodiments of the present disclosure, at least two PDCCH monitoring windows of the plurality of PDCCH monitoring windows may overlap in the time domain.

In such case, the UE may detect the respective RA-RNTIs corresponding to the at least two PDCCH monitoring windows in the overlapped portion of the at least two PDCCH monitoring windows according to some embodiments of the present disclosure.

For example, referring to FIG. 9, a UE may transmit, to a BS, a plurality of PRACH repetitions (e.g., PRACHs 1-4) on a plurality of ROs (e.g., ROs 1-4) during a random access procedure. The plurality of PRACH repetitions may be transmitted in slots #n to slot #n+1.

For example, according to the methods as described above or other methods that can be conceived of by persons skilled in the art, the UE may determine a plurality of PDCCH monitoring windows (e.g., window 1 and window 2 in FIG. 9) and may monitor a PDCCH in each of the PDCCH monitoring windows. The UE may determine a respective RA-RNTI in a corresponding window. For example, the UE may determine RA-RNTI #A1 corresponding to window 1 and determine RA-RNTI #A2 corresponding to window 2. For example, window 1 may be determined according to RO 2 in an RO group including ROs 1 and 2, and window 2 may be determined according to RO 4 in an RO group including ROs 3 and 4. For example, RA-RNTI #A1 may be determined according to RO 2 and RA-RNTI #A2 may be determined according to RO 4.

In some embodiments of the present disclosure, the UE may attempt to detect a DCI format with a CRC scrambled by RA-RNTI #A1 in window 1, and attempt to detect a DCI format with a CRC scrambled by RA-RNTI #A2 in window 2. More specifically, in the overlapped portion 913 of windows 1 and 2, the UE may attempt to detect both RA-RNTI #A1 and RA-RNTI #A2. In portion 911 of window 1 and portion 915 of window 2, the UE may attempt to detect RA-RNTI #A1 and RA-RNTI #A2, respectively.

In some embodiments of the present disclosure, the UE may detect a single RA-RNTI among the respective RA-RNTIs corresponding to the at least two PDCCH monitoring windows in the overlapped portion of the at least two PDCCH monitoring windows. The single RA-RNTI may be determined based on the priorities of the at least two PDCCH monitoring windows. For example, the single RA-RNTI is the RA-RNTI corresponding to the higher priority. In some embodiments of the present disclosure, the priority of a PDCCH monitoring window may be determined based on at least one of the following: a starting symbol of the PDCCH monitoring window; a starting symbol of an RO associated with the PDCCH monitoring window; or an index of an SSB or a CS (e.g., CSI-RS) associated with the RO.

For example, the PDCCH monitoring window with an earlier or later starting symbol has a higher priority. For example, a PDCCH monitoring window corresponding to an RO with an earlier or later starting symbol has a higher priority. For example, a PDCCH monitoring window corresponding to an RO associated with the smaller or bigger SSB index or CSI-RS index has a higher priority.

For example, it is assumed that a PDCCH monitoring window corresponding to an RO with an earlier starting symbol has a higher priority. Still referring to FIG. 9, window 2 has a higher priority than window 1 since window 2 corresponds to RO 1 or RO 2, window 2 corresponds to RO 3 or RO 4, ROs 1 and 2 precede ROs 3 and 4. In the overlapped portion 913 of windows 1 and 2, the UE may attempt to detect only RA-RNTI #A1. More specifically, the UE may attempt to detect RA-RNTI #A1 in window 1 and may attempt to detect RA-RNTI #A2 in portion 915 of window 2.

In some embodiments of the present disclosure, the UE may transmit the plurality of PRACH repetitions with a plurality of beams in operation 411. The beam for the PDCCH monitoring in a PDCCH monitoring window may be determined from the plurality of beams according to the PRACH repetition or the RO (e.g., at least one PRACH repetition of the plurality of PRACH repetitions or at least one RO of the plurality of ROs).

In the context of the present disclosure, “the beam for A is the beam of a PRACH repetition” may mean that the DMRS for A has the same antenna port quasi-collocation parameters as the SSB or CSI-RS associated with the PRACH repetition.

In some embodiments of the present disclosure, the beam for the PDCCH monitoring in the PDCCH monitoring window may correspond to a beam of a predefined PRACH repetition of the plurality of PRACH repetitions or a beam of a predefined RO of the plurality of ROs.

For example, the predefined PRACH repetition may be the earliest (first) PRACH repetition of the plurality of PRACH repetitions. For example, the predefined RO may be the earliest (first) RO of the plurality of ROs. The earliest RO can also be referred to as the RO of the earliest PRACH repetition.

For example, referring back to FIGS. 5A-5D and 7-9, the UE may transmit PRACHs 1-4 with a plurality of beams on ROs 1-4. The beam for the PDCCH monitoring in the PDCCH monitoring window may correspond to the beam of the first PRACH repetition (i.e., PRACH 1) of PRACHs 1-4.

For example, the predefined PRACH repetition may be the last PRACH repetition of the plurality of PRACH repetitions. For example, the predefined RO may be the last RO of the plurality of ROS. The last RO can also be referred to as the RO of the last PRACH repetition.

For example, referring back to FIGS. 5A-5D and 7-9, the UE may transmit PRACHs 1-4 with a plurality of beams on ROs 1-4. The beam for the PDCCH monitoring in the PDCCH monitoring window may correspond to the beam of the last PRACH repetition (i.e., PRACH 4) of PRACHs 1-4.

In some embodiments of the present disclosure, the beam for the PDCCH monitoring in the PDCCH monitoring window may include a set of beams, each of which may correspond to a respective PRACH repetition group of a plurality of PRACH repetition groups including the plurality of PRACH repetitions or a respective RO of a plurality of RO groups including the plurality of ROs.

The number of ROs in an RO group or the number of PRACH repetitions in a PRACH group can be equal to or greater than 1. The methods for determining the plurality of RO groups and the plurality of PRACH groups as described above may apply here.

In some embodiments of the present disclosure, the UE may use each of the set of beams in the PDCCH monitoring window for PDCCH monitoring, which means that the UE could swap beams in the PDCCH monitoring window.

For example, referring back to FIGS. 5A-5D, the UE may transmit PRACHs 1-4 with a plurality of beams on ROs 1-4 in some embodiments. The UE may use each of the plurality of beams for monitoring the PDCCH in the PDCCH monitoring window.

For example, referring to FIG. 7, it is assumed that window 3 is the final window for PDCCH monitoring, and the UE may transmit PRACHs 1-4 with a plurality of beams on ROs 1-4. The UE may use each of the plurality of beams for monitoring the PDCCH in window 3.

In some embodiments of the present disclosure, the UE may use a respective beam of the set of beams in a corresponding sub-window of a plurality of sub-windows, wherein the PDCCH monitoring window includes the plurality of sub-windows.

For example, the plurality of PRACH repetitions (or the plurality of ROs) may be divided into a plurality of PRACH repetition groups (or a plurality of RO groups), the PDCCH monitoring window may be divided into a plurality of sub-windows, and each sub-window may correspond to a PRACH repetition group (or a RO group). As mentioned above, the number of group members in a PRACH repetition group or an RO group can be equal to or greater than 1. For each sub-window, the UE may use a corresponding beam in the set of beams, which can be determined based on the corresponding PRACH repetition group (or corresponding RO group). For example, the beam for a predefined (e.g., last or first) PRACH repetition in the corresponding PRACH repetition group may be used as the beam in the corresponding sub-window for PDCCH monitoring. For example, in the case that the number of group members is equal to 1, the set of beam may refer to the plurality of beams for PRACH repetition transmission.

For example, referring to FIG. 8, the UE may transmit PRACHs 1-4 with a plurality of beams on a plurality of ROs (e.g., ROs 1-4) in some embodiments. The UE may determine a PDCCH monitoring window as shown in FIG. 8 according to various methods as described above or other methods that can be conceived of by persons skilled in the art. The PDCCH monitoring window is divided into 4 sub-windows (i.e., sub-windows #1 to #4), each correspond to one of ROs 1-4. Therefore, in this example, the set of beam refers to the plurality of beams for transmitting PRACHs 1-4. The UE may use a respective beam of the plurality of beams in each of sub-windows #1 to #4. For example, the UE may use the beam for PRACH 1 or RO 1 in sub-window #1, use the beam for PRACH 2 or RO 2 in sub-window #2, use the beam for PRACH 3 or RO 3 in sub-window #, and the UE may use the beam for PRACH 4 or RO 4 in sub-window #4.

In some embodiments of the present disclosure, the UE may use a respective beam of the set of beams in a corresponding window of a plurality of PDCCH monitoring windows, wherein the PDCCH monitoring window includes the plurality of PDCCH monitoring windows. The plurality of PDCCH monitoring windows can overlap or not overlap each other.

For example, according to the methods as described above or other methods that can be conceived of by persons skilled in the art, the UE may determine a plurality of PDCCH monitoring windows and may monitor a PDCCH in each of the PDCCH monitoring windows. For each PDCCH monitoring window, the UE may use a respective beam of the set of beams in the corresponding window.

For example, referring to FIG. 7, windows 1 and 2 can be determined according to the last RO of a corresponding RO group or the last PRACH of a corresponding PRACH group. For example, window 1 can be determined according to RO 2 in group #1′or PRACH 2 in group #1, and window 2 can be determined according to RO 4 in group #2′or PRACH 4 in group #2. It is assumed that the UE may determine window 1 and window 2 as the plurality of PDCCH monitoring windows. That is, the UE may monitor a PDCCH in window 1 and monitor a PDCCH in window 2.

In window 1 and window 2, the UE may use respective beams of a set of beams, which may respectively correspond to group #1′and group #2′or respectively correspond to group #1 and group #2. For example, the set of beams may include a beam for a predefined (e.g., the last or first) PRACH of group #1 and a beam for a predefined (e.g., the last or first) PRACH of group #2. For example, assuming that the predefined PRACH is the last PRACH, the UE may use the beam for PRACH 2 in window 1 for PDCCH monitoring and use the beam for PRACH 4 in window 2 for PDCCH monitoring.

In the case that the number of group members in an RO group or a PRACH repetition group is equal to 1, the set of beam may refer to the plurality of beams for PRACH repetition transmission.

In some embodiments of the present disclosure, at least two PDCCH monitoring windows of the plurality of PDCCH monitoring windows may overlap in the time domain.

In such case, the UE may use the respective beams corresponding to the at least two PDCCH monitoring windows in the overlapped portion of the at least two PDCCH monitoring windows according to some embodiments of the present disclosure.

For example, referring to FIG. 9, according to the methods as described above or other methods that can be conceived of by persons skilled in the art, the UE may determine window 1 and window 2 for PDCCH monitoring. For example, window 1 may be determined according to RO 2 in an RO group including ROs 1 and 2, and window 2 may be determined according to RO 4 in an RO group including ROs 3 and 4. In some examples, the UE may determine that the set of beams includes the beam for PRACH 2 and the beam for PRACH 4. The UE may use the beam for PRACH 2 in window 1 for PDCCH monitoring and use the beam for PRACH 4 in window 2 for PDCCH monitoring. More specifically, in the overlapped portion 913 of windows 1 and 2, the UE may use both the beam for PRACH 2 and the beam for PRACH 4 for PDCCH monitoring. In portion 911 of window 1 and portion 915 of window 2, the UE may use the beam for PRACH 2 and the beam for PRACH 4, respectively.

In some embodiments of the present disclosure, the UE may use a single beam among the respective beams corresponding to the at least two PDCCH monitoring windows in the overlapped portion of the at least two PDCCH monitoring windows. The single beam may be determined based on the priorities of the at least two PDCCH monitoring windows. For example, the single beam is the beam corresponding to the higher priority.

In some embodiments of the present disclosure, the priority of a PDCCH monitoring window may be determined based on at least one of the following: a starting symbol of the PDCCH monitoring window; a starting symbol of an RO associated with the PDCCH monitoring window; or an index of an SSB or a CS (e.g., CSI-RS) associated with the RO.

For example, the PDCCH monitoring window with an earlier or later starting symbol has a higher priority. For example, a PDCCH monitoring window corresponding to an RO with an earlier or later starting symbol has a higher priority. For example, a PDCCH monitoring window corresponding to an RO associated with the smaller or bigger SSB index or CSI-RS index has a higher priority.

For example, it is assumed that a PDCCH monitoring window corresponding to an RO with an earlier starting symbol has a higher priority. Still referring to FIG. 9, window 2 has a higher priority than window 1 since window 2 corresponds to RO 1 or RO 2, window 2 corresponds to RO 3 or RO 4, ROs 1 and 2 precede ROs 3 and 4. In the overlapped portion 913 of windows 1 and 2, the UE may only use the beam for PRACH 4 for PDCCH monitoring. More specifically, the UE may use the beam for PRACH 2 in window 1 for PDCCH monitoring and use the beam for PRACH 4 in portion 915 of window 2 for PDCCH monitoring.

In some embodiments of the present disclosure, the UE may determine a beam for a subsequent process of the transmission of the plurality of PRACH repetitions according to the beam for the PDCCH monitoring in the PDCCH monitoring window.

In some embodiments of the present disclosure, the subsequent process may include at least one of: a reception of a PDSCH (e.g., the RAR or activation command for BFR) scheduled by the PDCCH, a message 3 transmission (e.g., in operation 203 in FIG. 2), a message 4 reception (e.g., in operation 204 in FIG. 2), or a PUCCH transmission after the PDCCH monitoring.

In some embodiments of the present disclosure, the beam for the subsequent process of the transmission of the plurality of PRACH repetitions is the same as the beam for receiving the PDCCH in response to the PDCCH monitoring. For example, in the case that the beam for the PDCCH monitoring includes more than one beam, the UE may only receive a PDCCH(s) on a single beam or a subset of the more than one beam. The beam for the subsequent process may be the same as the single beam or the subset of beams.

It should be appreciated by persons skilled in the art that the sequence of the operations in exemplary procedure 400 may be changed and some of the operations in exemplary procedure 400 may be eliminated or modified, without departing from the spirit and scope of the disclosure.

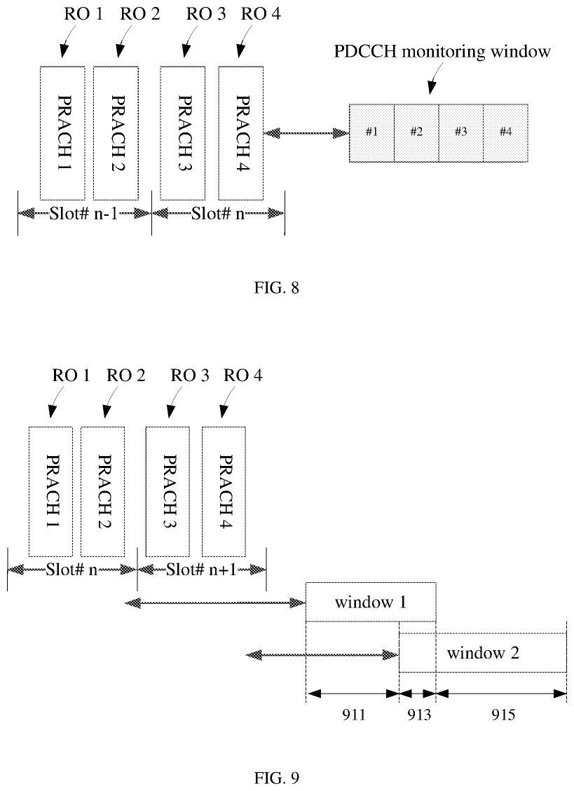

FIG. 10 illustrates a flow chart of an exemplary procedure 1000 for receiving PRACH repetitions in accordance with some embodiments of the present disclosure. Procedure 1000 may be implemented by a network entity (e.g., BS 102 as shown in FIG. 1). Details described in all of the foregoing embodiments of the present disclosure are applicable for the embodiments shown in FIG. 10.

Referring to FIG. 10, in operation 1011, a network entity may receive, from a UE, a plurality of PRACH repetitions for a random access procedure, a BFR procedure, or a link recovery procedure in a plurality of ROs. The definition of the ROs as described above (e.g., with respect to FIG. 4) may apply here.

In some embodiments of the present disclosure, the network entity may need to know whether a PRACH is transmitted with repetition or not. For example, the network entity may determine to receive the plurality of PRACH repetitions in response to receiving a specific PRACH preamble or in response to receiving a PRACH preamble in a specific PRACH occasion.

In some embodiments of the present disclosure, the number of PRACH repetitions in the plurality of PRACH repetitions may be configured in a PRACH configuration table, or may be configured per a PRACH format, or may be associated with a corresponding PRACH preamble or a corresponding RO. For example, different PRACH preambles may correspond to different numbers of PRACH repetitions.

In operation 1013, the network entity may transmit, to the UE, a PDCCH according to a PRACH repetition of the plurality of PRACH repetitions or an RO of the plurality of ROs.

In some embodiments of the present disclosure, the PDCCH may be transmitted in a PDCCH monitoring window which may be determined according to the PRACH repetition or the RO. For example, the PDCCH monitoring window may be determined according to at least one PRACH repetition of the plurality of PRACH repetitions. For example, the PDCCH monitoring window may be determined according to at least one RO of the plurality of ROs.

The methods for determining the PDCCH monitoring window as described above may apply here.

For example, in some embodiments of the present disclosure, in the case of the plurality of PRACH repetitions is for the BFR procedure or the link recovery procedure, the plurality of ROs or the plurality of PRACH repetitions may be in the same slot. The PDCCH monitoring window may be determined according any RO of the plurality of ROs or any PRACH of the plurality of PRACH repetitions.

For example, in some embodiments of the present disclosure, the starting symbol of the PDCCH monitoring window may be determined according to a predefined RO of the plurality of ROs or according to a predefined PRACH repetition of the plurality of PRACH repetitions.

For example, the predefined PRACH repetition may be the last PRACH repetition of the plurality of PRACH repetitions. For example, the predefined RO may be the last RO of the plurality of ROS. The last RO can also be referred to as the RO of the last PRACH repetition.

For example, the predefined PRACH repetition may be the earliest (first) PRACH repetition of the plurality of PRACH repetitions. For example, the predefined RO may be the earliest (first) RO of the plurality of ROs. The earliest RO can also be referred to as the RO of the earliest PRACH repetition.

In some embodiments of the present disclosure, the network entity may receive, from the UE, a set of PRACH repetitions for the random access procedure, the BFR procedure or the link recovery procedure no later than a time offset (e.g., offset #1) after an ending symbol of the PDCCH monitoring window or after an ending symbol of a PDSCH reception scheduled by the PDCCH. This may suggest a PDCCH monitoring failure at the UE.

In some embodiments of the present disclosure, the number of PRACH repetitions of the set of PRACH repetitions is greater than or equal to the number of PRACH repetitions of the plurality of PRACH repetitions. Or put another way, the repetition number of the PRACH may be equal to or larger than the initial PRACH transmission.

In some embodiments of the present disclosure, the network entity may transmit, to the UE, a difference between the number of PRACH repetitions of the set of PRACH repetitions and the number of PRACH repetitions of the plurality of PRACH repetition. In some embodiments of the present disclosure, the difference may be predefined.

In some embodiments of the present disclosure, in the case that the predefined RO is not the last RO or the predefined PRACH repetition is not the last PRACH repetition, a length of the PDCCH monitoring window may be based on at least one of: (A) a configurable window duration; (B) a repetition period of the plurality of PRACH repetitions (or a repetition period of the plurality of ROs); or (C) a time difference between the predefined PRACH repetition and the last PRACH repetition of the plurality of PRACH repetitions (a time difference between the predefined RO and the last RO of the plurality of ROs). For example, the network entity may configure the window duration to the UE. The descriptions regarding the determination of the length of the PDCCH monitoring window mentioned above may apply here and thus are omitted herein.

In some embodiments of the present disclosure, the PDCCH monitoring window may be determined based on a plurality of PDCCH monitoring windows. The starting symbol of each of the plurality of PDCCH monitoring windows may be determined according to a respective RO group of a plurality of RO groups including the plurality of ROs or a respective PRACH group of a plurality of PRACH groups including the plurality of PRACH repetitions. The number of ROs in an RO group or the number of PRACH repetitions in a PRACH group can be equal to or greater than 1.

The descriptions regarding the determination of the plurality of PDCCH monitoring windows mentioned above may apply here. The descriptions regarding the RO group and PRACH group mentioned above may apply here.

In some embodiments of the present disclosure, the network entity receive, from the UE, a set of PRACH repetitions for the random access procedure, the BFR procedure or the link recovery procedure no later than a time offset (e.g., offset #1) after an ending symbol of the last window of the plurality of PDCCH monitoring windows or after an ending symbol of a PDSCH reception scheduled by the PDCCH. This may suggest a PDCCH monitoring failure at the UE.

In some embodiments of the present disclosure, the number of PRACH repetitions of the set of PRACH repetitions is greater than or equal to the number of PRACH repetitions of the plurality of PRACH repetitions. Or put another way, the repetition number of the PRACH may be equal to or larger than the initial PRACH transmission.

In some embodiments of the present disclosure, the network entity may transmit, to the UE, a difference between the number of PRACH repetitions of the set of PRACH repetitions and the number of PRACH repetitions of the plurality of PRACH repetition. In some embodiments of the present disclosure, the difference may be predefined.

In some embodiments of the present disclosure, the PDCCH monitoring window may be a single PDCCH monitoring window formed by combining the plurality of PDCCH monitoring windows.

In some embodiments of the present disclosure, the starting symbol of the earliest window of the plurality of PDCCH monitoring windows and an ending symbol of the last window of the plurality of PDCCH monitoring windows may be determined as a starting symbol and an ending symbol of the (final) PDCCH monitoring window, respectively.

In some embodiments of the present disclosure, the number of ROs (e.g., Q) in an RO group of the plurality of RO groups, the number of RO groups (e.g., N) of the plurality of RO groups, or both are configurable by the network entity or predefined. The plurality of ROs can be grouped as the plurality of RO groups based on, for example, the number of repetitions of the plurality of PRACH repetitions (or the number of ROs of the plurality of ROs) and one of N and Q.

In some embodiments of the present disclosure, the number of PRACH repetitions (e.g., Q′) in a PRACH group of the plurality of PRACH groups, the number of PRACH groups (e.g., N′) of the plurality of PRACH groups, or both are configurable by the network entity or predefined. The plurality of PRACH repetitions can be grouped as the plurality of PRACH groups based on, for example, the number of repetitions of the plurality of PRACH repetitions (or the number of ROs of the plurality of ROs) and one of N′ and Q′.

In some embodiments of the present disclosure, the starting symbol of a respective PDCCH monitoring window of the plurality of PDCCH monitoring windows may be determined according to a predefined RO in the respective RO group or a predefined PRACH repetition in the respective PRACH group.

In some embodiments of the present disclosure, the predefined RO may be the earliest (first) or last RO. In some embodiments of the present disclosure, the predefined PRACH repetition may be the earliest (first) or last PRACH repetition.

As detailed before, from the perspective of a UE, after the PRACH transmission, it may need to detect one or more RA-RNTIs in a PDCCH monitoring window(s) according to various methods as described above. Similarly, the network entity may also determine one or more RA-RNTIs in the PDCCH monitoring window(s). However, the network entity may only transmit a DCI format with the CRC scrambled by one specific of the one or more RA-RNTIs in a corresponding PDCCH monitoring window. Accordingly, the UE may receive the DCI format with the CRC scrambled by the specific RA-RNTI.

As mentioned above, the network entity may transmit a PDCCH according to a PRACH repetition of the plurality of PRACH repetitions or an RO of the plurality of ROs in operation 1013. In some embodiments of the present disclosure, transmitting the PDCCH may include transmitting a DCI format with a CRC scrambled by an RA-RNTI in a PDCCH monitoring window, wherein the RA-RNTI is determined according to the PRACH repetition or the RO.

In some embodiments of the present disclosure, the RA-RNTI may be determined according to a predefined RO of the plurality of ROs or an RO of a predefined PRACH prepetition the plurality of PRACH repetitions. In this case, the UE may only need to detect one RA-RNTI in the PDCCH monitoring window.

For example, the predefined PRACH repetition may be the last (or first) PRACH repetition of the plurality of PRACH repetitions. For example, the predefined RO may be the last (or first) RO of the plurality of ROs. The last (or first) RO can also be referred to as the RO of the last (or first) PRACH repetition.

In some embodiments of the present disclosure, the RA-RNTI is determined according to a plurality of RA-RNTIs, each of which is determined according to a respective RO group of a plurality of RO groups including the plurality of ROs. The methods for determining the plurality of RA-RNTIs as described above may apply here. As for how to determine one RA-RNTI from the plurality of RA-RNTIs, it may be based on the implementation of the network entity, considering that the which RNTI is used by the network entity, so the UE should monitor each RNTI in the respective PDCCH monitoring window.

For example, in some embodiments of the present disclosure, each RA-RNTI of the plurality of RA-RNTIs may correspond to a sub-window of a plurality of sub-windows, wherein the PDCCH monitoring window may include the plurality of sub-windows. For example, in some embodiments of the present disclosure, each RA-RNTI of the plurality of RA-RNTIs may correspond to a window of a plurality of PDCCH monitoring windows, wherein the PDCCH monitoring window may include the plurality of PDCCH monitoring windows. The network entity may transmit one PDCCH with an RNTI selected from the plurality of RA-RNTIs in a corresponding PDCCH monitoring window.

For example, in some embodiments of the present disclosure, in the case that at least two PDCCH monitoring windows of the plurality of PDCCH monitoring windows overlap in a time domain, a single RA-RNTI among respective RA-RNTIs corresponding to the at least two PDCCH monitoring windows may correspond to the overlapped portion of the at least two PDCCH monitoring windows.

The methods for determining the single RA-RNTI as described above may apply here. For example, the single RA-RNTI may be determined based on the priorities of the at least two PDCCH monitoring windows. The methods for determining the priority of a PDCCH monitoring window as described above may apply here. For example, the priority of a PDCCH monitoring window may be determined based on at least one of the following: a starting symbol of the PDCCH monitoring window; a starting symbol of an RO associated with the PDCCH monitoring window; or an index of an SSB or a CS (e.g., CSI-RS) associated with the RO.

As detailed before, from the perspective of a UE, it may transmit a plurality of PRACH repetitions with a plurality of beams, and may use one or more beams from the plurality of beams for PDCCH monitoring in the PDCCH monitoring window(s). Similarly, the network entity may determine the one or more beams from the plurality of beams corresponding to a PDCCH monitoring window(s). However, the network entity may select a specific beam from the one or more beams for the actual PDCCH transmission. Accordingly, the UE may receive a PDCCH with the specific beam.

In some embodiments of the present disclosure, the plurality of PRACH repetitions received by the network entity in operation 1011 may be transmitted with a plurality of beams. The beam for transmitting the PDCCH in a PDCCH monitoring window may be determined from the plurality of beams according to the PRACH repetition or the RO.

In some embodiments of the present disclosure, the beam for transmitting the PDCCH in the PDCCH monitoring window may correspond to a beam of a predefined PRACH repetition of the plurality of PRACH repetitions or a beam of a predefined RO of the plurality of ROs.

For example, the predefined PRACH repetition may be the earliest (first) PRACH repetition of the plurality of PRACH repetitions. For example, the predefined RO may be the earliest (first) RO of the plurality of ROs. The earliest RO can also be referred to as the RO of the earliest PRACH repetition.

For example, the predefined PRACH repetition may be the last PRACH repetition of the plurality of PRACH repetitions. For example, the predefined RO may be the last RO of the plurality of ROS. The last RO can also be referred to as the RO of the last PRACH repetition.

In some embodiments of the present disclosure, the beam for transmitting the PDCCH in the PDCCH monitoring window may be determined from a set of beams among the plurality of beams, each beam of the set of beams may correspond to a respective PRACH repetition group of a plurality of PRACH repetition groups including the plurality of PRACH repetitions or a respective RO of a plurality of RO groups including the plurality of ROs. As for how to determine one beam from the plurality of beams, it may be based on the implementation of the network entity, considering that the UE does not know which beam is used by the network entity, so the UE should swap beams in the PDCCH monitoring window.

The methods for determining the set of beams among the plurality of beams as described above may apply here.

For example, in some embodiments of the present disclosure, each beam of the set of beams may correspond to a sub-window of a plurality of sub-windows, wherein the PDCCH monitoring window may include the plurality of sub-windows. Accordingly, the UE could use a respective beam in a respective sub-window.

For example, in some embodiments of the present disclosure, each beam of the set of beams may correspond to a window of a plurality of PDCCH monitoring windows, wherein the PDCCH monitoring window may include the plurality of PDCCH monitoring windows. Accordingly, the UE could use a respective beam in a respective PDCCH monitoring window.

For example, in the case that at least two PDCCH monitoring windows of the plurality of PDCCH monitoring windows overlap in a time domain, a single beam among respective beams may correspond to the at least two PDCCH monitoring windows corresponds to the overlapped portion of the at least two PDCCH monitoring windows.

The methods for determining the single beam as described above may apply here. For example, the single beam may be determined based on the priorities of the at least two PDCCH monitoring windows. The methods for determining the priority of a PDCCH monitoring window as described above may apply here. For example, the priority of a PDCCH monitoring window may be determined based on at least one of the following: a starting symbol of the PDCCH monitoring window; a starting symbol of an RO associated with the PDCCH monitoring window; or an index of an SSB or a CS (e.g., CSI-RS) associated with the RO.

In some embodiments of the present disclosure, in the case that the plurality of PRACH repetitions is transmitted with a plurality of beams, the network entity may determine a beam for a subsequent process of the reception of the plurality of PRACH repetitions according to a beam for transmitting the PDCCH.

In some embodiments of the present disclosure, the subsequent process may include at least one of: a transmission of a PDSCH scheduled by the PDCCH, a message 3 reception, a message 4 transmission, or a PUCCH reception after the PDCCH transmission.

In some embodiments of the present disclosure, the beam for the subsequent process of the reception of the plurality of PRACH repetitions may be the same as the beam for transmitting the PDCCH.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

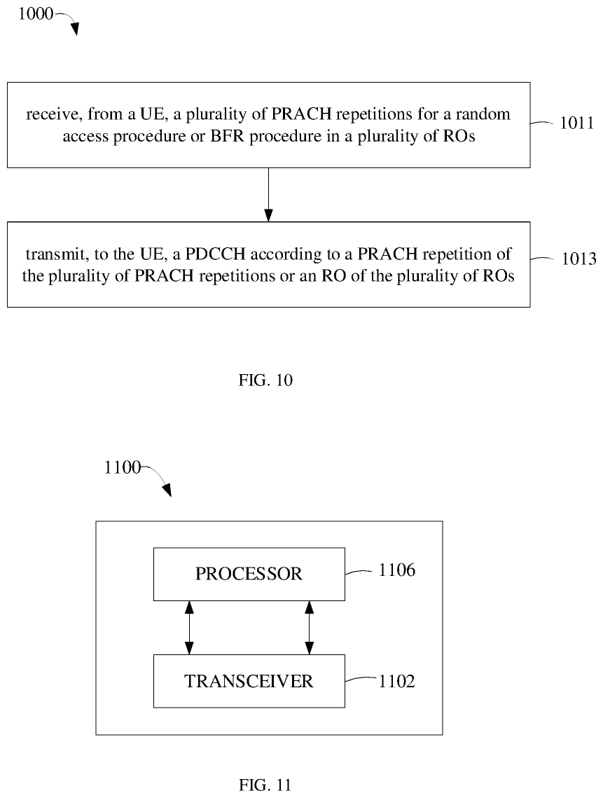

FIG. 11 illustrates a block diagram of an exemplary apparatus 1100 according to some embodiments of the present disclosure. As shown in FIG. 11, the apparatus 1100 may include at least one processor 1106 and at least one transceiver 1102 coupled to the processor 1106. The apparatus 1100 may be a UE or a network entity such as a BS.

Although in this figure, elements such as the at least one transceiver 1102 and processor 1106 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE. The transceiver 1102 and the processor 1106 may interact with each other so as to perform the operations with respect to the UE described in FIGS. 1-10. In some embodiments of the present application, the apparatus 1100 may be a BS. The transceiver 1102 and the processor 1106 may interact with each other so as to perform the operations with respect to the BS described in FIGS. 1-10.

In some embodiments of the present application, the apparatus 1100 may further include at least one non-transitory computer-readable medium.

For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

In some embodiments of the present disclosure, the non-transitory computer-readable medium may have stored thereon computer-executable instructions to cause the processor 1106 to implement the method with respect to the BS as described above. For example, the computer-executable instructions, when executed, cause the processor 1106 interacting with transceiver 1102 to perform the operations with respect to the BS described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
transmit a plurality of physical random access channel (PRACH) repetitions, for a random access procedure in a plurality of random access channel (RACH) occasions (ROs); and
monitor a physical downlink control channel (PDCCH) according to a an RO of the plurality of ROS.

2. The UE of claim 1, wherein the PDCCH is monitored in a PDCCH monitoring window which is determined according to the PRACH repetition or the RO.

3. The UE of claim 2,
wherein a starting symbol of the PDCCH monitoring window is determined according to a predefined RO of the plurality of ROs or according to a predefined PRACH repetition of the plurality of PRACH repetitions.

4. The UE of claim 3, wherein the at least one processor is configured to cause the UE to, in response to successfully monitoring the PDCCH, cancel a PRACH repetition of the plurality of PRACH repetitions, wherein a starting symbol of the cancelled PRACH repetition occurs after a second time offset relative to an ending symbol of a control resource set (CORESET) where the PDCCH is detected or an ending symbol of a physical downlink shared channel (PDSCH) reception scheduled by the PDCCH.

5. The UE of claim 1, wherein monitoring the PDCCH comprises detecting a downlink control information (DCI) format with a cyclic redundancy check (CRC) scrambled by a random access radio network temporary identifier (RA-RNTI) in a PDCCH monitoring window according to the RO.

6. The UE of claim 5,
wherein the RA-RNTI is determined according to a predefined RO of the plurality of ROs; or
wherein the RA-RNTI comprises a plurality of RA-RNTIs, each of which is determined according to a respective RO group of a plurality of RO groups including the plurality of ROs.

7. The UE of claim 1, wherein the plurality of PRACH repetitions is transmitted with a plurality of beams, and wherein a beam for the PDCCH monitoring in a PDCCH monitoring window is determined from the plurality of beams according to the PRACH repetition or the RO.

8. The UE of claim 7,
wherein the beam for the PDCCH monitoring in the PDCCH monitoring window corresponds to a beam of a predefined PRACH repetition of the plurality of PRACH repetitions or a beam of a predefined RO of the plurality of ROs; or
wherein the beam for the PDCCH monitoring in the PDCCH monitoring window comprises a set of beams, each of which corresponds to a respective PRACH repetition group of a plurality of PRACH repetition groups including the plurality of PRACH repetitions or a respective RO of a plurality of RO groups including the plurality of ROS.

9. The UE of claim 8, wherein the predefined RO is the earliest or last RO; or
wherein the predefined PRACH repetition is the earliest or last PRACH repetition.

10. A network entity, comprising:
at least one memory; and
at least one processor coupled with the at least one memory and configured to cause the network entity to:
receive, from a user equipment (UE), a plurality of physical random access channel (PRACH) repetitions, for a random access procedure in a plurality of random access channel (RACH) occasions (ROs); and
transmit, to the UE, a physical downlink control channel (PDCCH) according to a an RO of the plurality of ROs.

11. The network entity of claim 10, wherein the PDCCH is transmitted in a PDCCH monitoring window which is determined according to the PRACH repetition or the RO.

12. The network entity of claim 11,
wherein a starting symbol of the PDCCH monitoring window is determined according to a predefined RO of the plurality of ROs or according to a predefined PRACH repetition of the plurality of PRACH repetitions.

13. The network entity of claim 10, wherein transmitting the PDCCH comprises transmitting a downlink control information (DCI) with a cyclic redundancy check (CRC) scrambled by a random access radio network temporary identifier (RA-RNTI) in a PDCCH monitoring window, wherein the RA-RNTI is determined according to the RO.

14. The network entity of claim 10, wherein the plurality of PRACH repetitions is transmitted with a plurality of beams, and wherein a beam for transmitting the PDCCH in a PDCCH monitoring window is determined from the plurality of beams according to the PRACH repetition or the RO.

15. A method performed by a user equipment (UE), the method comprising:
transmitting a plurality of physical random access channel (PRACH) repetitions, for a random access procedure in a plurality of random access channel (RACH) occasions (ROs); and
monitoring a physical downlink control channel (PDCCH) according to an RO of the plurality of ROs.

16. A processor for wireless communication, comprising:
at least one controller coupled with at least one memory and configured to cause the processor to:
transmit a plurality of physical random access channel (PRACH) repetitions, for a random access procedure in a plurality of random access channel (RACH) occasions (ROs); and
monitor a physical downlink control channel (PDCCH) according to an RO of the plurality of ROS.

17. The processor of claim 16, wherein the PDCCH is monitored in a PDCCH monitoring window which is determined according to the PRACH repetition or the RO.

18. The processor of claim 17,
wherein a starting symbol of the PDCCH monitoring window is determined according to a predefined RO of the plurality of ROs or according to a predefined PRACH repetition of the plurality of PRACH repetitions.

19. The processor of claim 18, wherein the at least one controller is configured to cause the processor to, in response to successfully monitoring the PDCCH, cancel a PRACH repetition of the plurality of PRACH repetitions, wherein a starting symbol of the cancelled PRACH repetition occurs after a second time offset relative to an ending symbol of a control resource set (CORESET) where the PDCCH is detected or an ending symbol of a physical downlink shared channel (PDSCH) reception scheduled by the PDCCH.

20. The processor of claim 16, wherein monitoring the PDCCH comprises detecting a downlink control information (DCI) format with a cyclic redundancy check (CRC) scrambled by a random access radio network temporary identifier (RA-RNTI) in a PDCCH monitoring window according to the RO.
